(19) United States
(12) Patent Application Publication
(10) Pub. No.: US 2011/0200058 A1
(43) Pub. Date: Aug. 18, 2011

(54) HYPOTHESIS-BASED FRAME SYNCHRONIZATION IN A DIGITAL COMMUNICATIONS SYSTEM

(76) Inventors: Mordechai Mushkin, Nirit (IL); Ronen Gazit, Tel Aviv (IL)

(21) Appl. No.: 13/025,846

(22) Filed: Feb. 11, 2011

Related U.S. Application Data
(60) Provisional application No. 61/304,288, filed on Feb. 12, 2010.

(51) Int. Cl. H04J 3/24

(52) U.S. Cl. 370/475

(57) ABSTRACT

A hypothesis-based frame synchronization mechanism for use in a digital communications system, such as a powerline based communications network. The receiver detects the start of a preamble and achieves symbol synchronization. To achieve frame synchronization, the receiver generates a plurality of candidate hypotheses, each hypothesis corresponding to a potential starting point for the header section of the packet. The receiver evaluates each candidate hypothesis and selects the hypothesis having the highest likelihood of being valid. Frame synchronization is based on the selected hypothesis and detection and decoding of the data portion of the packet proceeds in accordance with the selected hypothesis.

REFERENCE TO PRIORITY APPLICATION

This application claims priority to U.S. Provisional Application Ser. No. 61/304,288, filed Feb. 12, 2010, entitled “Digital Communication Methods and Systems,” incorporated herein by reference in its entirety.

### FIELD OF THE DISCLOSURE

The subject matter disclosed herein relates to the field of digital communications, and more particularly relates to hypothesis-based frame synchronization for use in a communications system.

### SUMMARY OF THE INVENTION

There is thus provided in accordance with the invention, a method of synchronization for use in a communication system coupled to a communications medium, the method comprising receiving a packet over the communications medium, the packet comprising a preamble having a plurality of preamble symbols and a data portion having a plurality of data symbols, determining symbol synchronization based on detection of one or more preamble symbols, generating a plurality of candidate hypotheses, each candidate hypothesis comprising a different sequence of symbols, determining a likelihood value of each candidate hypothesis indicating the likelihood the candidate hypothesis is valid, and selecting a candidate hypothesis based on the likelihood values.

There is also provided in accordance with the invention, a method of synchronization for use in a Power Line Carrier (PLC) based communication system connected to a power line utility, the method comprising receiving a packet over the power line utility, the packet comprising a preamble portion having a plurality of preamble symbols and a data portion having a plurality of header symbols and data symbols, obtaining symbol synchronization based on positive detection of one or more preamble symbols, generating a plurality of hypotheses, each hypothesis comprising a unique sequence of received symbols, determining a likelihood value for each hypothesis, the likelihood value representing the probability of a particular hypothesis being valid, and selecting one of the hypotheses having a corresponding likelihood value indicating it is most likely to be valid.

There is further provided in accordance with the invention, a modem for use in a Power Line Carrier (PLC) based communication system connected to a power line utility comprising a transmitter operative to generate and transmit packets over the power line utility, each packet comprising a preamble portion consisting of preamble symbols and a data portion consisting of data symbols, a receiver coupled to the power line utility and operative to receive packets over the power line utility, obtain symbol synchronization based on positive detection of one or more preamble symbols in a receive packet, generate a plurality of hypotheses, each hypothesis comprising a unique sequence of received symbols, determine a likelihood value of each hypothesis, the likelihood value representing the probability of a particular hypothesis being valid, and select one of the hypotheses having a corresponding likelihood value indicating it is most likely to be valid.

There is also provided in accordance with the invention, a method of digital communications, the method comprising transmitting a packet comprising a preamble portion and a data portion, wherein the preamble portion comprises a plurality of preamble symbols and the data portion comprises a plurality of data symbols and wherein the duration of each preamble symbol is an integer multiple of the duration of at least a portion of the data symbols.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the mechanism of the present invention;

FIG. 2 is a high level block diagram illustrating an example communications system adapted to implement the mechanism of the present invention;

FIG. 3 is a diagram illustrating an example format of a packet or frame;

FIG. 4 is a high level block diagram illustrating digital processing functions performed by the transmitter and the receiver portions of a modem in a single carrier communication system;

FIG. 5 is a high level block diagram illustrating digital processing functions performed by the transmitter and the receiver portions of a modem in an OFDM communication system;

FIG. 6 is a flow diagram illustrating an example spreading signal generation method of the present invention;

FIG. 7 is a diagram illustrating the operation of an example spreading modulator of the present invention;

FIG. 8 is a flow diagram illustrating an example matched filter template calculation method of the present invention;

FIG. 9 is a block diagram of a receiver of a single carrier based digital communication system comprising a matched-filter calculator;

FIG. 10 is a block diagram illustrating a receiver capable of operating without locking the AGC;

FIG. 11 is a diagram illustrating signals presented in several fixed and floating point formats;

FIG. 12A is a block diagram illustrating an example implementation of a floating point block process using fixed point arithmetic;

FIG. 12B is a block diagram illustrating an example implementation of a floating point convolution process using fixed point arithmetic;

FIG. 13 is a diagram illustrating an example format of a packet or frame in more detail;

FIG. 14 is a flow diagram illustrating an example hypothesis-based frame synchronization method of the present invention;

FIG. 15 is a diagram illustrating an example hypotheses-based frame synchronization mechanism in an OFDM communication system;

FIG. 16 is a diagram illustrating an example hypotheses-based frame synchronization mechanism in a single carrier communication system;

FIG. 17 is a flow diagram illustrating an example periodic noise estimation method of the present invention;

FIG. 18 is a diagram illustrating an example mechanism for estimating the pattern of temporal variations of the noise in a single carrier communication system;

FIG. 19 is a diagram illustrating an example mechanism for estimating the pattern of temporal variations of the noise in an OFDM communication system;

FIG. 20 is a flow diagram illustrating an example periodic channel estimation method of the present invention;

FIG. 21 is a diagram illustrating an example mechanism for estimating a periodically varying channel response in a single carrier system;

FIG. 22 is a diagram illustrating an example mechanism for estimating a periodically varying channel response in an OFDM system;

FIG. 23 is a diagram illustrating an example time diversity mechanism in a single carrier system;

FIG. 24 is a diagram illustrating an example time diversity mechanism in an OFDM system;

FIG. 25 is a flow diagram illustrating an example variable duration header generation and transmission method of the present invention;

FIG. 26 is a diagram illustrating the generation of an example variable size header for use with the variable header duration mechanism of the present invention; and

FIG. 27 is a flow diagram illustrating an example variable duration header process for detecting and decoding the variable length header.

### DETAILED DESCRIPTION

The present invention is a digital communications system that addresses the problems associated with communicating over channels in the presence of various noise and channel impairments. The digital communications system employs several techniques for combating the various noise and channel impairments exhibited by the channel (e.g., a PLC channel). These techniques include a spreading signal generation scheme, a matched filter template calculation scheme, a gain compensation scheme, a floating point arithmetic scheme, a hypothesis-based frame synchronization technique, a periodic noise estimation scheme, a periodic channel estimation scheme, an adaptive bit loading technique, elimination of the guard interval technique, a time diversity technique and use of a variable duration header scheme.

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

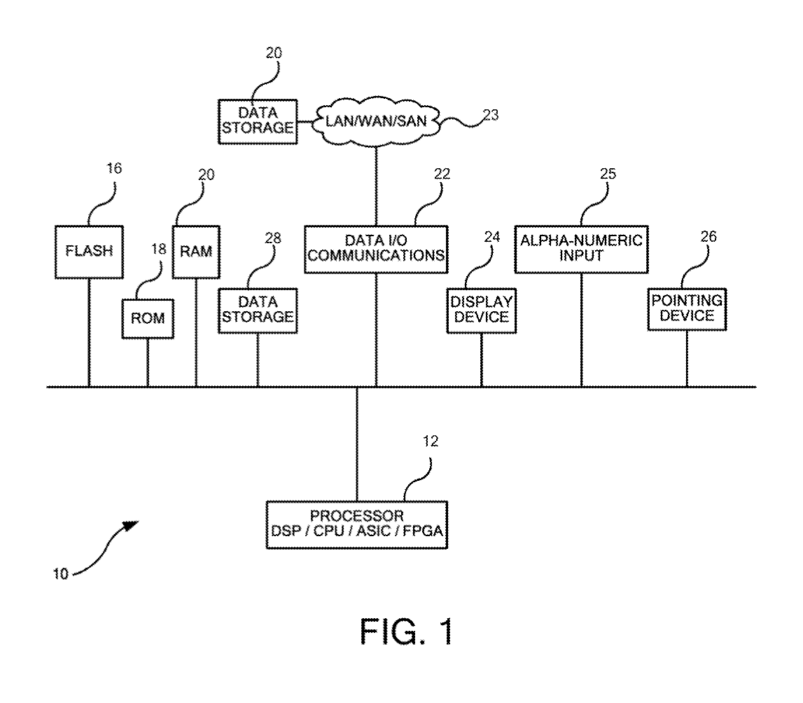

A block diagram illustrating an example computer processing system adapted to implement the system and methods of the present invention is shown in FIG. 1. The computer system, generally referenced 10, comprises a processor 12 which may comprise a digital signal processor (DSP), central processing unit (CPU), microcontroller, microprocessor, microcomputer, ASIC or FPGA core. The system also comprises static read only memory 18 and dynamic main memory 20 all in communication with the processor. The processor is also in communication, via bus 14, with a number of peripheral devices that are also included in the computer system. Peripheral devices coupled to the bus include a display device 24 (e.g., monitor), alpha-numeric input device 25 (e.g., keyboard) and pointing device 26 (e.g., mouse, tablet, etc.)

The computer system is connected to one or more external networks such as a LAN or WAN 23 via communication lines connected to the system via data I/O communications interface 22 (e.g., network interface card or NIC). The network adapters 22 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 21 and/or 28 for storing application programs and data. The system comprises computer readable storage medium that may include any suitable memory means, including but not limited to, magnetic storage, optical storage, semiconductor volatile or non-volatile memory or any other memory storage device.

Software adapted to implement the system and methods of the present invention is adapted to reside on a computer readable medium, such as a magnetic disk within a disk drive unit. Alternatively, the computer readable medium may comprise a floppy disk, removable hard disk, Flash memory 16, EEROM based memory, bubble memory storage, ROM storage, distribution media, intermediate storage media, execution memory of a computer, and any other medium or device capable of storing for later reading by a computer a computer program implementing the method of this invention. The software adapted to implement the system and methods of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the system and methods of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or by combinations of special purpose hardware and computer instructions.

### Example Communications System

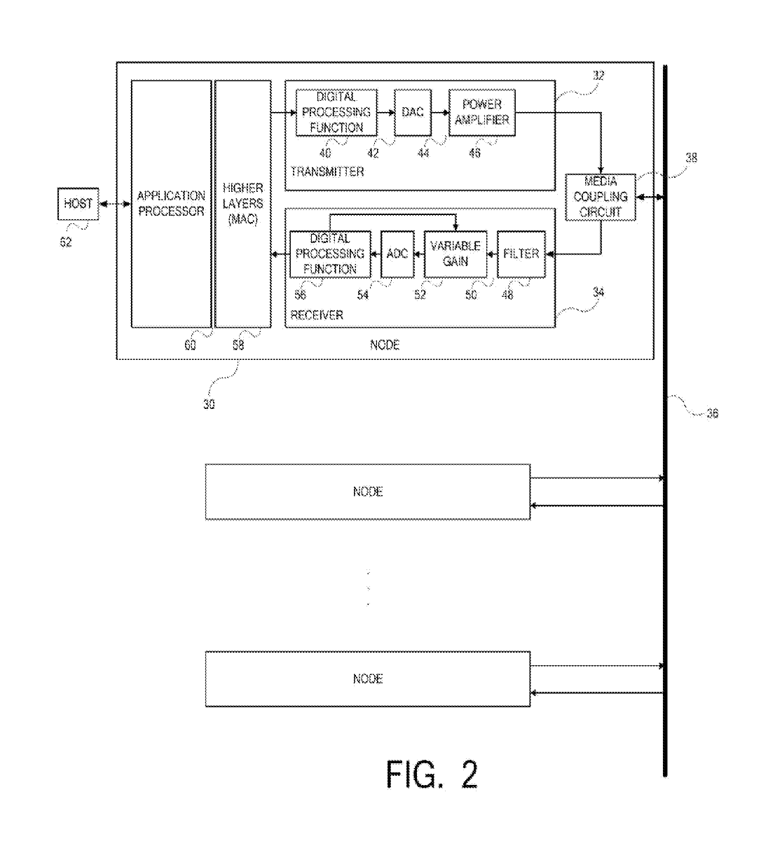

A high level block diagram illustrating an example communications system adapted to implement the mechanism of the present invention is shown in FIG. 2. The communication system typically comprises a plurality of nodes 30, coupled to a media 36 (e.g., the power line). In one embodiment, a node comprises a transmitter 32, a receiver 34, a media coupling circuit 38, higher layers 58 (e.g., MAC) and optionally an application processor 60 having an interface to a host 62. In some cases, a node may comprise only a transmitter or only a receiver. In an alternative embodiment, the MAC and the application layers may be implemented by the same processor. Further, the interface may be to some other entity and not necessarily a host. The application may, in one embodiment, comprise the host, e.g., in the event the node is connected to a utility meter or to an appliance.

The transmitter typically comprises a digital processing function 40, a digital to analog convertor (DAC) 42 and a power amplifier 44. The receiver typically comprises a filter 50, a variable gain device 52, an analog to digital convertor (ADC) 54 and a digital processing function 56. The receiver may also comprise a low noise amplifier (not shown) before or after the variable gain device 52. The digital processing functions 40 and 56 may be implemented using dedicated digital circuitry, general purpose processors, digital signal processors (DSP), or any combinations thereof. Media coupling circuit 38 provides the interface for the transmitter and receiver to the media 36.

A digital communication system transmits digital information from a first node (referred to as the transmitting node) to a second node (referred to as the receiving node) over the transmission media 36. The media coupling circuit 38 couples the transmitter and the receiver to the transmission media. In wireless systems, the media coupling circuit typically comprises an antenna. In wired systems, the media coupling circuit typically comprises a coupler connecting the nodes to the wires.

In some wired communication systems, the transmission media may comprise a network of dedicated wires. In other communication systems, the transmission media may comprise a network of wires with another primary use. For example, the transmission media of power line communication (PLC) systems is an outdoor and/or an in-house electric grid.

A communication system utilizes a given part of the electromagnetic spectrum, referred to as the transmission band or the operation band. For example, some PLC systems operate within the 2 to 50 MHz band, referred to as the high PLC band. Some PLC systems operate within the 0 to 500 kHz band, referred to as the low PLC band. More specifically, some PLC systems operate within the 20 to 95 kHz band, the 95 to 125 kHz band and the 0 to 500 kHz band, referred to as the CELENEC A, the CENELEC B, and the FCC bands, respectively.

The path over the transmission media connecting the transmitting node to the receiving node is referred to as the propagation channel or simply the channel. The channel is characterized by its response, which can be expressed in the time domain as the channel impulse response or in frequency domain as the channel frequency response. In some cases, the frequency response of the channel is relatively “flat”, while in other cases the frequency response of the channel may exhibit considerable gain and phase variations over the transmission band. In some cases, the channel response is relatively stable over time, while in other cases the channel response may exhibit considerable temporal variations. In some cases, the temporal variations of the channel response follow a periodic pattern. In some cases, for example in PLC systems, the channel response changes periodically, at a period that is half of the AC cycle (e.g., at a period of 8⅓ or 10 ms for mains frequency of 60 or 50 Hz, respectively).

The signal received by the receiver comprises a desired signal combined with undesired noise. The desired signal is the transmitted signal, modified by the channel according to the channel response. The noise comprises internal noise that originates at the receiver, e.g., thermal noise and external undesired electromagnetic signals, referred to as ingress noise or interference. In some communication systems, for example in PLC systems, the ingress noise is much stronger than the internal receiver noise. In some cases, the spectrum of the ingress noise is relatively flat, while in other cases, it may change considerably over frequency. In some cases, the ingress noise may be relatively constant over time, while in other cases, it may change considerably over time. In some cases, the temporal variations of the ingress noise may be periodic. In some PLC systems, for example, the ingress noise varies periodically with a period equal to half of the period of the AC cycle. Furthermore, in many PLC channels, the ingress noise varies periodically between a quiet sub-period and a noisy sub-period where the difference in the noise level between the quiet and noisy sub-periods may exceed 10 or even 20 db.

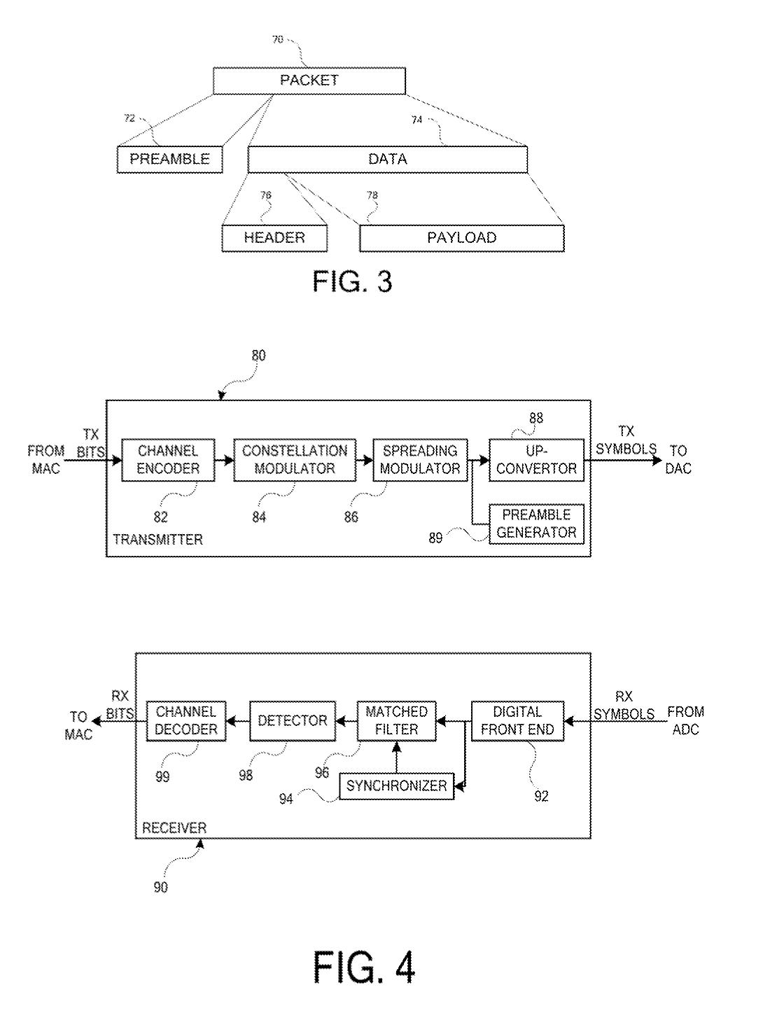

A diagram illustrating an example format of a typical packet (also referred to as frame) is shown in FIG. 3. In many digital communication systems, information is transmitted from the transmitting node to the receiving node in a form of packets (or frames). The packet 70 typically comprises a preamble 72 and a data portion 74 which comprises a header portion 76 and a payload portion 78. The payload portion typically carries the content of the packet. The preamble, which comprises a known signal, is typically utilized by the receiver for detecting the beginning of a new packet, for time synchronization and for channel estimation. The payload portion usually comprises the content of the packet. The transmission parameters of the payload portion usually vary between packets and are therefore usually not known a priori to the receiver. The header portion, whose parameters are typically known a priori to the receiver, usually comprises the parameters of the payload portion thus enabling the receiver to detect and decode the payload.

The spectrum of the preamble signal is typically essentially flat over the transmission band and its autocorrelation is consequently relatively close to an impulse response (or more accurately to a sin(x)/x function), which makes the preamble suitable for time synchronization and for channel estimation. The receiver typically comprises a synchronizer which processes the preamble. The functions of the synchronizer typically comprise (1) indicating the beginning of a new packet, (2) performing time synchronization, and (3) performing channel estimation.

Communication systems comprise, for example, single-carrier (SC) systems and OFDM systems. In OFDM systems, the preamble typically comprises one or more OFDM symbols and channel estimation typically comprises estimation the complex gain of each OFDM bin.

A high level block diagram illustrating digital processing functions performed by the transmitter and the receiver portions of a modem in a single carrier (SC) communication system is shown in FIG. 4. The digital processing functions comprise transmitter 80 and receiver 90. Transmitter 80 typically comprises a channel encoder 82, a constellation modulator 84 and a preamble generator 89. Transmitter 80 may also comprise a spreading modulator 86 and/or an up convertor 88. Receiver 90 typically comprises a digital front end 92, a synchronizer 94, a matched filter 96, a detector 98 and a channel decoder 99.

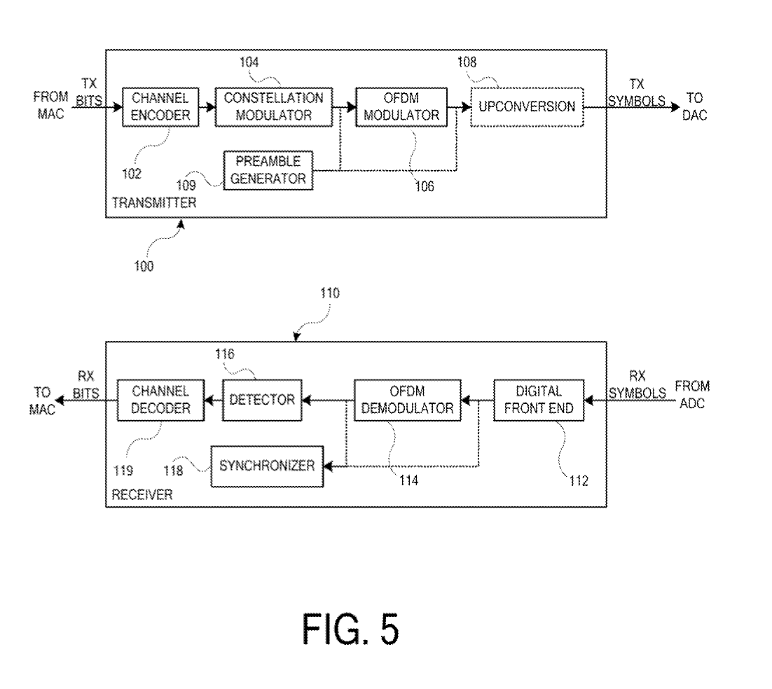

A high level block diagram illustrating digital processing functions performed by the transmitter and the receiver portions of a modem in an OFDM communication system is shown in FIG. 5. The digital processing functions comprise transmitter 100 and receiver 110. Transmitter 100 typically comprises a channel encoder 102, a constellation modulator 104, a preamble generator 109 and an OFDM modulator 106. Transmitter 100 may also comprise an upconverter 108. Receiver 110 typically comprises a digital front-end 112, an OFDM demodulator 114, a synchronizer 118116, a detector 116 and a channel decoder 119.

It is a common practice in communication systems to perform the digital functions of the transmitter and the receiver over complex baseband signals, which are converted to/from real baseband or passband transmitted/received over the media. Throughout this document ‘signals’ are referred to as complex signals.

### Spreading Signal Generation

In many single carrier communication systems, the signaling rate of the constellation modulator is at the same order as the Nyquist frequency of the transmission band. Thus, the transmitted signal essentially occupies the entire transmission band. The signaling rate of the constellation modulator is referred to as the signaling rate of the transmitter or just the signaling rate.

In some communication systems, however, the signaling rate may be substantially lower than the Nyquist frequency. For example, the signaling rate of the YT900 PLC modem manufactured by Yitran Communications Ltd, Beersheva, Israel when operating over the 120 to 400 kHz portion of the FCC band, can be selected to be about 400, 320, 160, 80, 40 or 20 kHz, where the rate is selected in accordance with the channel conditions.

In such cases, a spreading modulator is typically used in order to expand the transmission signal over the entire transmission band. With reference to FIG. 4, spreading modulator 86 is located at the output of constellation modulator 84. Spreading modulation is commonly performed by convolving the output of the constellation modulator by a spreading signal.

In one embodiment, the criteria for designing the spreading signals typically comprise the following: (1) the duration of the spreading signal is preferably close to the signaling period (i.e. the reciprocal of the signaling rate); (2) the spectrum of the spreading signal preferably conforms to the transmission band (e.g., in accordance with any relevant government regulations); (3) the spectrum of the shaping signal is preferably as flat as possible; and (4) the peak to average of the shaping signal is preferably low as possible.

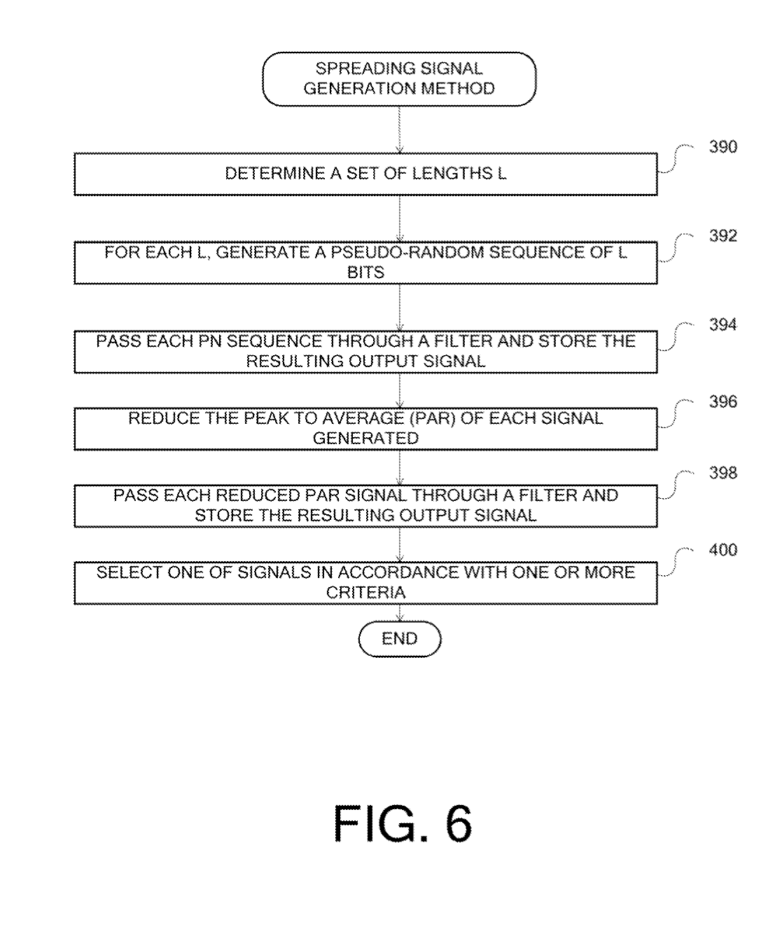

In one example embodiment, a procedure for generating spreading signals in accordance with the above criteria is provided as described infra. A flow diagram illustrating an example spreading signal generation method of the present invention is shown in FIG. 6.

A set of lengths L is determined, for example L=1, 3, 7, 15, 31, etc. (step 390). For each value of L, a pseudo random (PN) sequence of L bits is generated (step 392). It is appreciated that the set of lengths presented above is for illustration purposes only as any desired sequence may be generated. Each PN sequence is then passed through an appropriate filter and the resulting signal is recorded (step 394). The filter is typically adapted so that the spreading signal will match the transmission band and will comply with the applicable regulations. The peak to average (PAR) of each of the signals produced in step 394 is reduced, e.g., by applying a hard limit (step 396). Each of the reduced PAR signals produced in step 396 is passed through an appropriate filter and the resulting signal is stored (step 398). Note that the filter is typically adjusted to the transmission band. For every signaling period, the most suitable signal is selected in accordance with the criteria described supra (step 400). Selection is performed from among the set of all signals produced in steps 390, 392, 394, 396 and 398. Note that the selection may be performed automatically (via software or hardware or a combination thereof) or manually.

In an alternative embodiment, steps 396 and 398 are skipped. In another embodiment, steps 396 and 398 are performed once. In another embodiment, steps 396 and 398 are iterated several times.

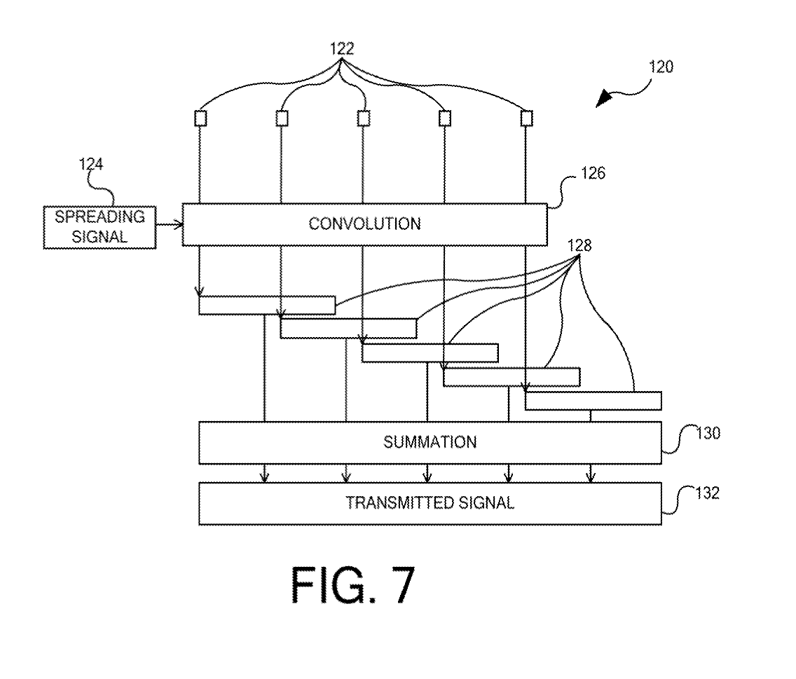

Note that the duration of a spreading signal (or spreading waveform) is typically longer than the respective signaling period. In those cases, the transmission signal is generated by summation of overlapping signals. A diagram illustrating the operation of an example spreading modulator of the present invention is shown in FIG. 7. Constellation symbols 122 are convolved (convolution block 126) with spreading signal 124 to generate spread symbols 128. The overlapping spread symbols 128 are summed (via summation block 130) with appropriate overlap to generate transmitted signal 132.

### Matched Filter Template Calculation

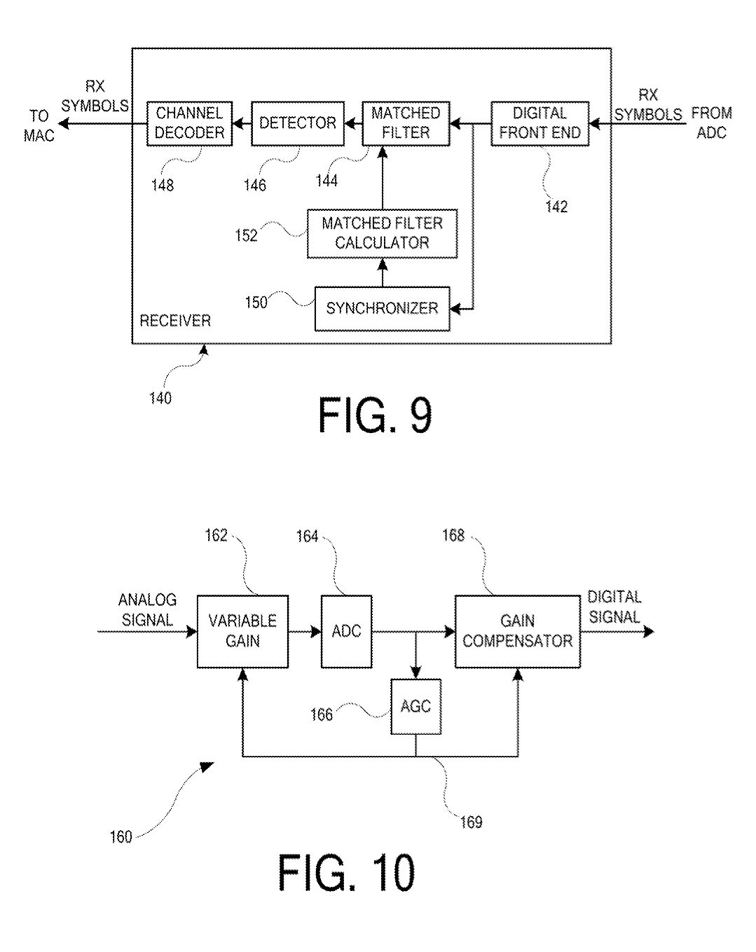

With reference to FIG. 4, the transmitter 80 of a single carrier digital communication system comprises constellation modulator 84, spreading modulator 86 and preamble generator 89. The receiver 90 comprises synchronizer 96, matched filter 94 and detector 98. A block diagram of a receiver of a single carrier based digital communication system comprising a matched filter calculator is shown in FIG. 9. Receiver 140, which is similar to respective receiver 90 (FIG. 4), further comprises a matched filter calculator 152, whose operation is described in more detail infra, in addition to a digital front end 142, synchronizer 150, matched filter 144, detector 146 and channel decoder 148.

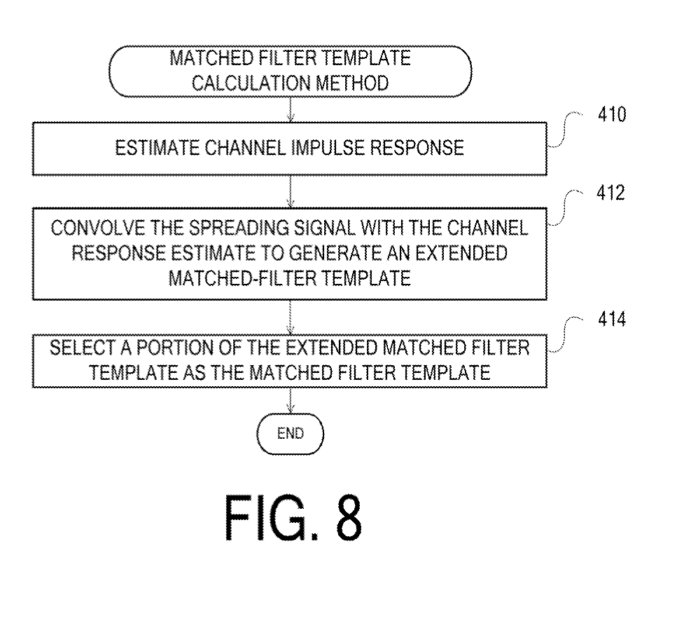

A flow diagram illustrating an example matched filter template calculation method of the present invention is shown in FIG. 8. During the synchronization stage, the received preamble signal is cross-correlated with a synchronization template and start of packet synchronization is determined by recognizing a strong peak at the output of the cross-correlator. The synchronization template is a signal whose cross-correlation with the synchronization symbol is substantially an impulse response. In many cases the synchronization template is equal or substantially equal to the synchronization symbol. In cases where the preamble comprises several symbols, the output values of the cross-correlator at respective distances may be combined to improve reliability.

When start of packet synchronization is determined, the impulse response of the channel is estimated (step 410) (by the synchronization block 150) by taking the output values of the cross-correlator at the vicinity of the peak. The estimated channel response is input to the matched filter calculator 152.

The matched filter calculator functions to calculate the matched filter template as follows. The spreading signal is convolved with the estimated channel impulse response to generate an extended matched filter template (step 412). The duration of the extended template is typically longer than the signaling duration, since (1) the spreading signal is typically longer than the signaling duration, and (2) the channel impulse response is usually longer than an impulse.

A portion of the extended matched filter template, whose length is equal to the signaling duration, is selected as the matched filter template (step 414). The portion is selected to provide a desired compromise between the level of the desired output and the level of the inter-symbol interference (ISI). In one embodiment. the level of the desired level is determined by calculating the scalar product of the selected template with itself. The level of the ISI is determined by calculating the absolute value of the scalar product of the selected template with the respective portion of the extended template shifted an integer number of signaling durations.

In many cases, detector 146 comprises a decision feedback equalizer (DFE). In these cases, the operation of the matched filter calculator is modified as follows. The matched filter template is selected to provide a desired compromise between the level of the desired output and the level of the non-causal ISI (since the causal ISI can be removed by the DFE). The DFE coefficients are determined by calculating the scalar product of the selected template with the respective portion of the extended template shifted a positive integer number of signaling durations.

### Gain Compensation

With reference to FIG. 2, receiver 34 comprises variable gain device 52 which functions to vary the gain of the received analog signal. ADC 54 is fed the gain adjusted analog signal and generates a digital signal which is fed to digital processing function 56. The purpose of variable gain device 52 is to maintain the signal at the input of ADC 54 as high as possible while keeping it low enough to prevent saturation and/or clipping at the ADC. The variable gain device is typically controlled by an automatic gain control (AGC) function (not shown) which checks the level of the signal at the output of the variable gain device and, in turn, controls the gain of the variable gain device accordingly. The output signal being checked is typically the digital output of the ADC. Additionally (or alternatively), the analog input of the ADC may be checked by a dedicated sensor.

In one embodiment, the AGC operates during idle intervals until a packet start is detected. Once the start of a packet is detected, the AGC is locked during the reception of the packet. Idle intervals refer to times when no packet is received and no packet is transmitted. Locking is performed because gain variations during packet reception usually interfere with the operation of the detector, e.g., by changing the channel response and/or the DFE coefficients. In OFDM systems, for example, gain variations within a received OFDM symbol might interfere with the proper operation of the ODFM demodulator.

In some communication systems, however, locking the AGC at the beginning of the packet is not desirable. For example, if the receiver operates with a negative signal to noise ratio (SNR) and the noise varies considerably during the reception of the packet, it is desirable that the AGC dynamically adjust the gain level to the noise level. In another example, several receivers from different communication systems incorporated within the same node may share the same analog front end circuit. In such cases, the AGC may be controlled, regularly or momentarily, by one receiver and therefore not locked by one of the other receivers.

A block diagram illustrating a receiver capable of operating without locking the AGC is shown in FIG. 10. Note that only the relevant portions of the receiver are shown for clarity purposes only. The receiver, generally referenced 160, comprises variable gain device 162, ADC 164 and AGC circuit 166. In addition, the receiver comprises a gain compensator circuit 168. The gain compensator is fed by the AGC with the same control signal 199 that feeds the variable gain device and is thus aware of the gain applied to the received signal.

In order to keep the gain of the digital signal observed by the receiver constant, even though the AGC is not locked, gain compensator 168 functions to divide (or compensate) the digital signal at is input by the momentary gain applied to the analog signal by the variable gain circuit 162, thus “undoing” the gain variations introduced by the AGC. Note that in some cases, the step size of the AGC is 6 dB. In these cases, the division can be performed by appropriate shifting of the bits representing the digital signal.

### Floating Point Arithmetic

In some receivers, the dynamic range of the signals being processed by the digital processing function is relatively high, e.g., in cases where gain compensation is applied, as shown in FIG. 10 supra. Consider, for example, the case where the instantaneous dynamic range of the ADC 164 is 10 bits and the dynamic range of AGC 166 is 60 db. In this case, the total dynamic range of the digital signals at the output of gain compensator 168 comprises 20 bits which is twice as high as the respective dynamic range in a typical receiver, where the AGC is locked during packet reception.

It is noted that gain compensator 168 functions to increase the dynamic range of the digital signal but does not increase the instantaneous resolution. In addition, the quantization error of ADC 164 is proportional to the gain. Therefore, in accordance with one embodiment of the invention, the digital signal is compactly represented using a mantissa plus exponent format where the mantissa corresponds to the output of the ADC and the exponent corresponds to the AGC setting. Referring to the above example, the input signal can be represented in a 14 bit mantissa plus exponent format (i.e. 10 bit mantissa and 4 bit binary exponent) rather than in a 20 bit fixed point format. Furthermore, since the variations of the AGC are relatively slow, additional saving may be achieved by decimating the exponent, where one common exponent applies to a block of samples. These savings are substantial and may be critical since the operation of the digital processing function of the receiver typically comprises maintaining large buffers of input samples and intermediate results.

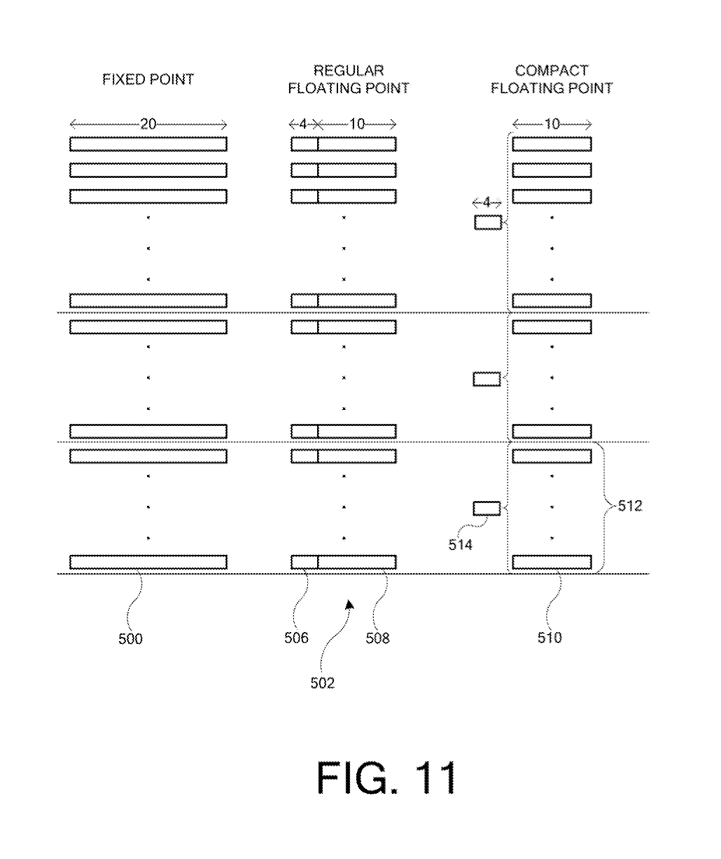

A diagram illustrating signals presented in several fixed and floating point formats is shown in FIG. 11. The signal representations comprise a fixed-point format 500, a regular floating point format 502 and a compact floating point format 504. In the example scheme of FIG. 11, the fixed point format 500 comprises 20-bits. The regular floating point format 502 comprises a 4-bit exponent 506 and 10-bit mantissa 508. In the regular floating point format each sample of the signal is represented by an individual exponent 506 and an individual mantissa 508. In the compact floating-point format 510 each sample is represented by an individual mantissa 510 and a block of samples 512 that is represented by a common exponent 514. The size of the block 512 may be either fixed or variable and may vary depending on the specific implementation. In some cases, for example, block 512 may comprise the real and imaginary (i.e. I and Q) dimensions of a given sample. In other cases, for example, block size 512 may be adapted to match the update rate of the AGC. In cases where the signals are processed in blocks (e.g., in OFDM systems), the size of block 512 is typically adapted to match the size processing block (e.g., the size of the OFDM symbols).

The floating point (mantissa plus exponent) presentation of the signals is also advantageous for reducing the processing complexity of the receiver. For example, it may be less complex to implement 4/10 (exponent/mantissa) floating point arithmetic than to implement 20 bit fixed point arithmetic.

In some embodiments, the arithmetic operations performed by the receiver may comprise a combination of floating-point and fixed-point operations. In some embodiments, the combination comprises locking (i.e. fixing) the exponent of the floating-point representation at a given point in the processing path and performing a major portion of the subsequent processing using fixed point operations applied to the mantissas of the signals.

For example, a receiver typically comprises a digital front end which functions to perform downconversion, and/or filtering (i.e. the removal of out-of-band interferences), and/or interference rejection (i.e. the removal of strong narrow in-band interferences). In some cases, the momentary dynamic range of the signal at the output of the digital front end is typically lower than the momentary dynamic range at its input, and therefore the output of the digital front end may be represented in fixed-point representation.

In another embodiment, synchronization, channel estimation and matched-filter template calculations may be calculated utilizing floating-point representation of signals whereby a dominant exponent of the estimated channel or the matched-filter template is used as a reference exponent for fixing the exponent at the output of the digital front end or at the output of the FFT.

In some embodiments, floating-point processing is performed by dedicated digital circuitry or by a digital processor with full floating-point functionality. In other embodiments, floating point processing is more efficiently implemented by a combination of conventional fixed-point processing and special exponent related processing. Following are some examples for cases of block operations (e.g., FFT, vector multiplication and other block operations), convolution operations (e.g., FIR filter, cross-correlation and other similar operations) and IIR filter operations.

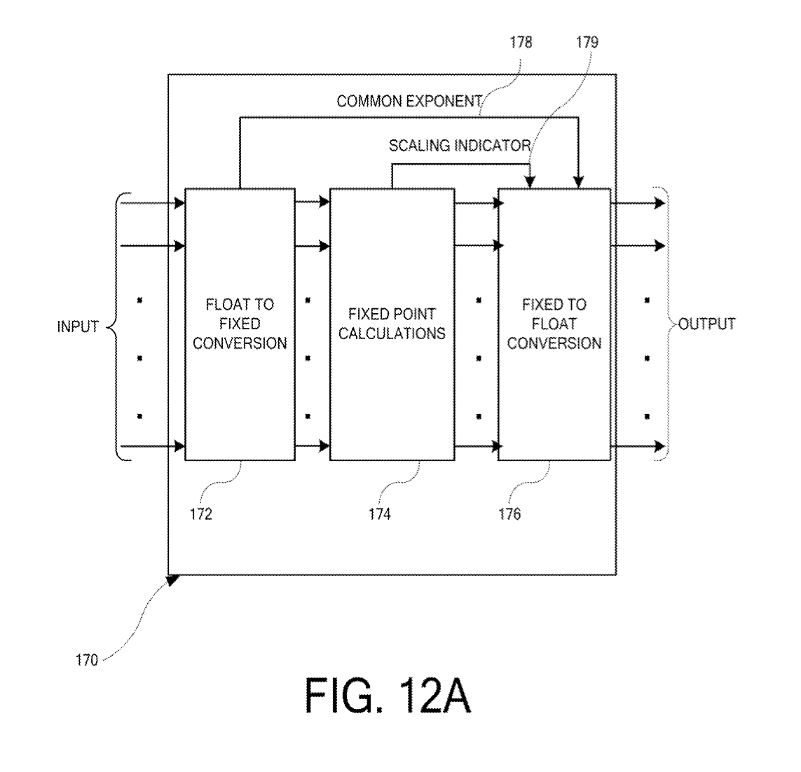

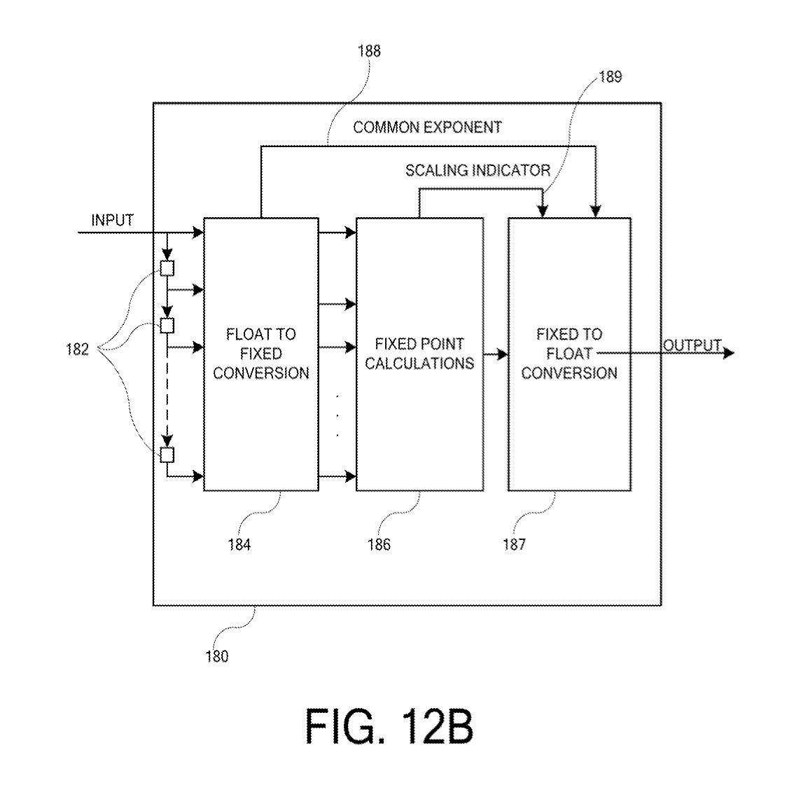

A block diagram illustrating an example implementation of a floating point block process using fixed point arithmetic is shown in FIG. 12A. The floating point block process, generally referenced 170, is implemented using a float-to-fix convertor 172, a fixed-point block processor 174 and a fixed-to-float convertor 176.

The operation of float-to-fixed convertor 172 generally comprises (1) determining a common exponent (usually the highest exponent of the input samples), (2) aligning the input samples to the common exponent, and (3) forwarding the common exponent to fixed-to-float convertor 176. In many cases, the operation of the float-to-fixed convertor is simplified, for example in cases where the format of the input block already comprises a common exponent 178.

The operation of fixed-point block processor 174 typically comprises block operations (e.g., FFT) implemented in conventional fixed point arithmetic. In some embodiments, the fixed-point block 174 also comprises scaling which may be either predetermined or adaptive to the input. In the latter case, a scaling indicator 179 on the actual scaling is forwarded to fixed-to-float convertor 176.

The operation of fixed-to-float convertor 176 generally comprises (1) determining an output common exponent (usually in accordance with the input common exponent and the scaling indicator), and (2) assigning the output common exponent to the output samples. In some embodiments, the operation of the fixed-to-float convertor also comprises normalization of the output samples. In many cases, the operation of the fixed-to-float convertor is simplified, for example, in cases where the format of the output block already comprises a common exponent.

A block diagram illustrating an example implementation of a floating point convolution process using fixed point arithmetic is shown in FIG. 12B. The floating point convolution process, generally referenced 180, is implemented utilizing a shift register 182, float-to-fix convertor 184, a fixed-point convolution processor 186 and a fixed-to-float convertor 187. Note that the scheme of FIG. 12B is similar to that of FIG. 12A with the main difference being the addition of shift register 182 and the fact that the process operates per sample (in FIG. 12B) rather than per block (in FIG. 12A).

### Hypothesis-Based Frame Synchronization

With reference to FIG. 3, example packet (or frame) 70 typically comprises a preamble portion 72 and data portion 74. The data portion typically comprises a header 76 and payload 78. The preamble, which comprises a known signal, is used by the receiver for synchronization purposes. In coherent communication systems, the preamble is typically also used to perform channel estimation. Synchronization comprises two tasks: (1) determining that a new packet is being received, which causes the receiver to enter packet-reception mode and to process the received packet; and (2) determining the actual starting point of the data portion 74.

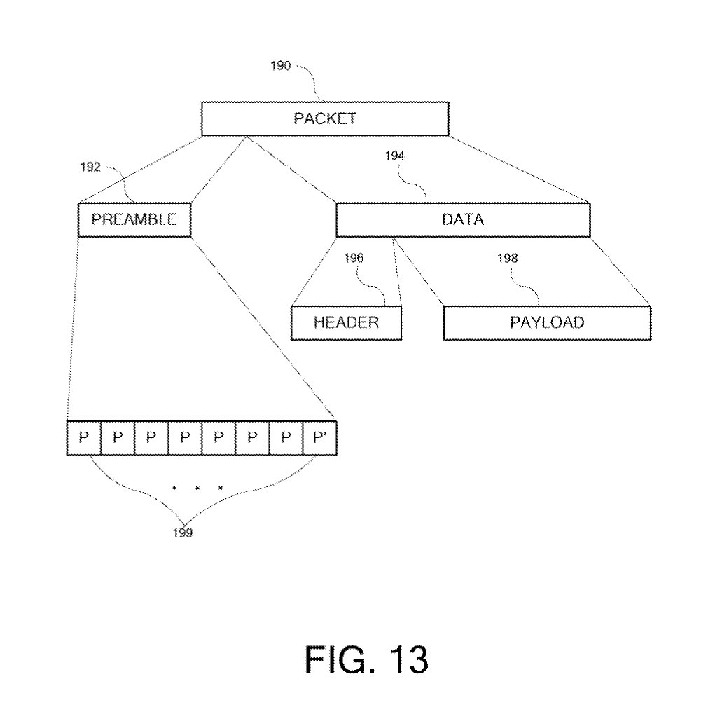

FIG. 13 is a diagram illustrating the format of a typical packet (frame) in more detail. The packet 190 comprises a preamble 192 and a data portion 194. In many cases the data portion comprises a header 196 and a payload 198. The transmission parameters of the header are typically known in advance, while the transmission parameters of the payload, which may typically vary between packets, are usually encoded in the header.

In many cases, the preamble comprises a plurality of preamble symbols 199 (typically identical) denoted in FIG. 13 by P. In some cases, however, the last preamble symbol is different from the previous preamble symbols, as explained in more detail infra. This last preamble symbol is denoted in FIG. 13 by P′ (P prime).

The preamble symbol 199 is typically designed to be a signal p(t) with duration T which is much longer than the channel impulse response h(t), and whose autocorrelation function Rₚ₍ₜ₎ has low side-lobes. During the synchronization stage, the received signal is cross-correlated with a synchronization template, which is typically equal to the preamble symbol p(t). This cross-correlation function is referred to as a correlator. Denoting the transmitted preamble symbol by p(t) and the channel impulse response by h(t), the received preamble symbol r(t) can be expressed as

r(t)=p(t)*h(t) (1)

where the symbol * denotes convolution.

When the received preamble symbol is cross-correlated with p(t), the output of the correlator x(t) is given by

x(t)=r(t)*p*(t)=p(t)*p*(−t)*h(t)=Rₚ₍ₜ₎·h(t)≈h(t) (2)

where (·)* denote the conjugate operation and Rₚ₍ₜ₎ denotes the auto-correlation function of p(t), which is close to an impulse function δ(t). Since the duration T of the preamble p(t) is typically selected to be much longer than the channel impulse response h(t), a received preamble symbol at the input of the correlator results in a peak h(t) at the output of the correlator. Furthermore, a sequence of received preamble symbols of duration T at the input of the correlator results in a sequence of peaks h(t) at the output of the correlator.

Synchronization of the packet is performed by observing the output of the correlator. The first task of the synchronization process, i.e. determining the existence of a new packet, may be performed in one embodiment by comparing the instantaneous power |x(t)|² at the output of the correlator with some threshold. In one embodiment, |x(t)|² is normalized by dividing it with the instantaneous power |r(t)² at the input of the correlator. In one embodiment, improved performance may be achieved by integrating the correlator output of several (N) received preamble symbols to yield z_{N}(t). This integration can be performed either coherently, i.e.

$${z}_{N} ( t ) = {\vert {\sum }_{n = 0}^{N - 1} x ( t - n \cdot T ) \vert}^{2} \qquad ( 3 )$$

or non-coherently, i.e.

$${z}_{N} ( t ) = {\sum }_{n = 0}^{N - 1} {\vert x ( t - n \cdot T ) \vert}^{2} . \qquad ( 4 )$$

The function which correlates the received signal with the synchronization template is referred to as the correlator. In one embodiment, the correlator may be implemented by linear correlation. Linear correlation may be implemented by straight forward convolution. Alternatively, linear correlation may be implemented more efficiently with the assistance of FFTs and IFFTs, using the well-known ‘overlap and add’ or the overlap and save' methods. Furthermore in another embodiment, due to the periodic structure of the preamble, the correlator may also be implemented using cyclic correlation which is usually performed by a sequence of an FFT, a frequency domain multiplication and an IFFT. Note that the complexity of an FFT/IFFT based cyclic correlation is lower than that of an FFT/IFFT based linear correlation (i.e. overlap and add or overlap and save), and therefore the former is usually the preferred method in OFDM systems, where the same FFT/IFFT function is typically used both for synchronization and for OFDM modulation and demodulation.

In one embodiment, the second task of the synchronization process, i.e. determining the endpoint of the preamble and the starting point of the data portion (which is typically the starting point of the header), can be performed by observing the output of the correlator. If (1) the preamble comprises a fixed number of symbols, and (2) each symbol produces a clear peak at the output of the correlator, then the receiver can count the number of the correlator peaks and determine the location of the last preamble symbol.

In some communication systems, however, the preamble may comprise a variable number of symbols, which might be unknown to the receiver. In some cases, the number of symbols in the preamble may be dynamically selected according to the expected channel conditions. For example, when the expected signal to noise is low, a longer preamble, comprising more symbols, may be transmitted to improve synchronization probability and channel estimation accuracy. In another example, when bursts of strong noise are expected, a longer preamble may be selected in order to ensure that enough symbols are received which are not affected by the burst.

Furthermore, even in cases where the preamble comprises of a fixed number of symbols, not all of them are always recognized by the receiver. In some cases, the first one or more symbols might be missed by the receiver due to one or more reasons, e.g., the time response of the AGC, FFT boundary alignment (in the event that the correlator is implemented using FFT), etc. In other cases, some of the preamble symbols may be missed due to one or more bursts of strong noise.

Due to the reasons above, the second task of synchronization is usually divided into two sub-tasks. In the first sub-task, referred to as symbol synchronization, the receiver determines the boundaries of one or more preamble symbols, without necessarily determining the location of the last preamble symbol. In the second sub-task, referred to as frame synchronization, the receiver determines the location of the last preamble symbol. The determination of the location of the last preamble symbol allows the receiver to begin reception of the header and data portions of the packet.

In some systems, in order to facilitate frame synchronization, the last symbol of the preamble (denoted in FIG. 13 by P′ (P prime)) is intentionally made different from the other preamble symbols (denoted in FIG. 13 by P). In such a system, the receiver is able to determine frame synchronization by recognizing a P′ preamble symbol rather a P preamble symbol. In some cases, the P′ symbol is selected to be equal to −P, in order to maximize the discrimination or differences between P and P′ preamble symbols.

In cases of intense temporal variations of the noise and/or in cases of very low SNR, however, the technique described above is not sufficiently reliable. Consider, for example, the case where the channel is subject to strong periodic noise having a duty cycle of approximately 50%. In such cases, which is quite common in PLC systems, the probability of missing the P′ preamble symbol is approximately 50%. Consider also, in another example, the case of very low SNR, where symbol synchronization can be achieved only by integrating multiple preamble symbols. In such a case, frame synchronization may fail if the SNR is too low to allow reliable discrimination between P and P′ (e.g., −P) preamble symbols based on a single preamble symbol.

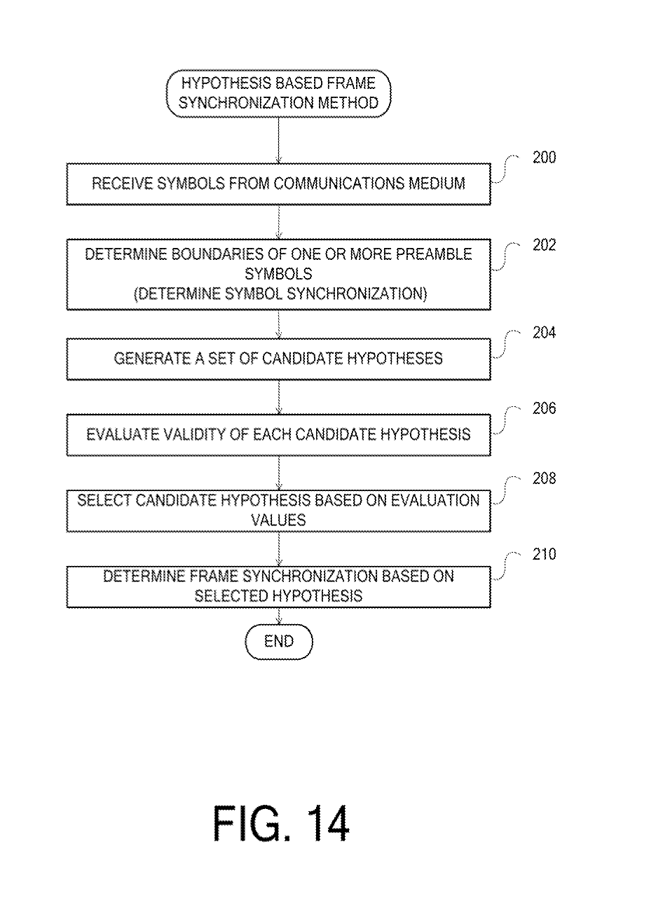

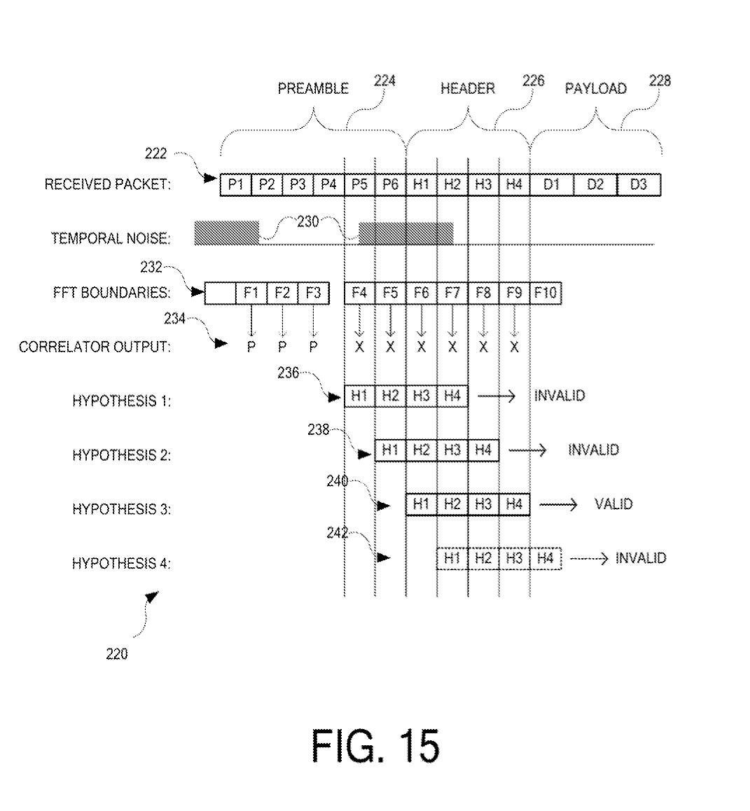

The invention overcomes the synchronization problems (i.e. synchronization ambiguity) described above by providing a hypothesis-based frame synchronization mechanism. A flow diagram illustrating an example hypothesis-based frame synchronization method of the present invention is shown in FIG. 14. A diagram illustrating an example hypotheses-based frame synchronization mechanism in an OFDM communication system is shown in FIG. 15.

With reference to FIGS. 14 and 15, the hypothesis-based frame synchronization scheme, generally referenced 220, comprises on the first line 222 a transmitted frame consisting of symbols received from the communications medium (step 200). The transmitted frame comprises a preamble portion 224, a header portion 226 and a payload portion 228. The preamble 224 comprises a plurality of identical preamble symbols, denoted P1 to P6. In this example, the preamble symbols comprise OFDM symbols, with no guard interval (cyclic prefix) between them. The header 226 comprises several OFDM symbols denoted H1 to H4. Unlike traditional OFDM systems, the header OFDM symbols H1 to H4 are not extended by a cyclic prefix and there is no guard interval between the symbols. Thus, the duration of each of the header symbols H1 to H4 is equal to the duration of each of the preamble symbols P1 to P6. Not extending the header symbols facilitates efficient hypotheses-based frame-synchronization, described in more detail infra. Note that the header is typically protected using error detection codes (e.g., CRC code) and encoded using powerful channel encoding, which typically comprises FEC encoding and interleaving. In many cases, the channel encoding farther comprises repetition encoding.

The second line of FIG. 15 illustrates two bursts 230 of high noise that affect the received packet. Note that all lines of FIG. 15 are displayed over a common time axis. In the example illustrated, the bursts of high noise corrupt preamble symbols P1, P5 and P6 along with header symbols H1 and H2. The burst noise is introduced in order to illustrate the operation of the hypothesis-based frame-synchronization in the presence of such noise. It is appreciated, however, that the hypothesis-based frame-synchronization mechanism is suitable in other applications as well, e.g., in cases where P′ is set equal to P, or in cases where the SNR is too low to distinguish between P and P′.

The third line 232 of FIG. 15 illustrates the boundaries at which the FFT process is applied to the received signal. Application of the FFT process is denoted as F1 to F10. Note that F1 is not necessarily the first application of the FFT process, but rather the first application relevant to the current description, hence it is labeled F1. The FFT application up to and including F3 are used for symbol synchronization purposes, by means of cyclic correlation, as commonly implemented in OFDM systems. Symbol synchronization is obtained after F3 and therefore F1 to F3 are not yet aligned with the preamble symbols. Only after F3 with the successful detection of two preamble symbols P2 and P3 is symbol alignment (symbol synchronization) achieved (step 202). Thus, FFT applications F4 to F10 are aligned on symbol boundaries. Note also that since the preamble symbols and the header symbols are of equal duration, alignment with the boundaries of the preamble symbols also implies alignment with the boundaries of the header symbols. Therefore, F4 to F10 are also aligned with the header symbols, which facilitate efficient processing of the hypotheses, as described in more detail infra.

The forth line 234 of FIG. 15 illustrates the output of the correlator. In the example embodiment presented, the correlator comprises a cyclic correlator, which is implemented by point by point multiplication of the output of the FFT by the frequency domain synchronization template, following by an IFFT. As described supra, the existence of a new packet is determined by detection of high energy in one or more bins of the IFFT output. Symbol synchronization is determined in accordance with the location of the highest energy bin. The symbols P in the forth line 234 of FIG. 15 indicate high correlation with the preamble symbol, while the symbols X indicate low correlation or an undetermined result. Note that low correlation or an undetermined result does not necessarily indicate that the respective OFDM symbol is not a preamble symbol as such a result may also be caused by the presence of high noise, as in the case of preamble symbols P1, P5 and P6. Note also that symbol synchronization is established, in this example, after a sequence of two high correlation indicators. This value (i.e. two high correlation indications) may vary depending on the configuration of the receiver, the level of the correlation indicators and the level of the noise.

In accordance with one embodiment, once symbol synchronization has been achieved, the receiver generates a plurality of potential starting points for the header section (i.e. data portion). Each potential starting point is referred to as a hypothesis. The receiver attempts to detect the header by evaluating each hypothesis and selecting one that has the highest likelihood of being valid. The last four lines 236, 238, 240, 242 illustrate hypothesis-based frame synchronization, wherein each line represents one candidate hypothesis being tested (evaluated) by the receiver. Each candidate hypothesis comprises four symbols corresponding to the four header symbols H1 through H4. The term hypothesis refers to a potential location of the last preamble symbol which determines a potential location of the first header symbol. In the example illustrated, the first candidate hypothesis 236 corresponds to the potential situation where P4 is the last preamble symbol, and H1 to H4 are located at the output of FFT applications F4 to F7, respectively. The second candidate hypothesis 238 corresponds to the potential situation where the last preamble and H1 to H4 are located at the output of FFT applications F4 to F8, respectively. The third candidate hypothesis 240 corresponds to the potential situation where the last preamble symbol and H1 to H4 are located at the output of FFT applications F5 to F9, respectively. The last candidate hypothesis 242 corresponds to the potential situation where the last preamble symbol and H1 to H4 are located at the output of FFT applications F6 to F10, respectively. In this example, candidate hypothesis 240 is valid while candidate hypotheses 236, 238 and 242 are invalid.

The receiver determines the set of candidate hypotheses in accordance with (1) the detected preamble symbols and (2) the number of the symbols per preamble (step 204). Note that in some cases the number of symbols in the preamble may vary (e.g., a dynamic number of preamble symbols are selected in accordance with expected channel conditions). In such cases the receiver determines the candidate hypotheses in accordance with the maximum number of symbols per preamble. The set of candidate hypotheses comprises a sequence of consecutive hypotheses ranging from the first hypothesis to the last hypothesis, wherein each candidate hypothesis is different.

The first hypothesis in the set is determined in accordance with to the location of the last preamble symbol being positively detected, denoted by P_{LAST}. According to the first hypothesis, H1 is located at the first FFT application after P_{LAST}. In the example of FIG. 15, P_{LAST} occurs at the output of F3. Thus, the first hypothesis assumes that H1 is located at the output of F4. Consider, as another example, the case where the output of the correlator corresponding to F4 is P rather than X. In this example, P_{LAST} occurs at the output of F4, and the first hypothesis would assume that H1 is located at the output of F5.

The last hypothesis is determined in accordance with (1) the location of the first preamble symbol being positively detected, denoted by P_{FIRST}, and/or (2) the maximal number of preamble symbols (the maximum being denoted by N_{MAX}). In accordance with the last hypothesis, H1 is located N_{MAX} FFT applications after P_{FIRST}. In the example of FIG. 15, P_{FIRST} occurs at the output of F2, and N_{MAX} is equal to six. Therefore, in this example, the last hypothesis assumes that H1 is located at the output of F7.

The receiver tests each hypothesis within the set of candidate hypotheses and evaluates its likelihood (e.g., generates an evaluation value) (step 206), selects a hypothesis based on the evaluation values (step 208) (e.g., the hypothesis corresponding to the highest likelihood), determines frame synchronization based on the selected hypothesis (step 210) and detects and decodes the data portion of the frame according to the selected hypothesis. In the example of FIG. 15, the receiver selects the third hypothesis 240, and detects and decodes the data portion of the frame in accordance with this hypothesis.

In many systems, the header is protected by an error-detection code, for example, a Cyclic Redundancy Code (CRC). In those cases, evaluating the likelihood of a given hypothesis may be performed by detecting and decoding the header according to the hypothesis and checking the CRC of the decoded header. If the CRC is valid, the likelihood of the hypothesis is very high and the hypothesis is selected.

Additionally (or alternatively), the likelihood of a given hypothesis is determined by detecting and decoding the header according to the hypothesis and determining reliability indications (soft metrics) produced by the channel decoder. For example, if the path metrics of all the paths of the Viterbi decoder of a convolutional code are low, the hypothesis is ranked to have low likelihood.

Additionally (or alternatively), the likelihood of a given hypothesis is determined based on detecting known symbols within the header symbols. In many coherent communication systems, known constellation symbols, usually referred to as pilots, are interleaved with the data carrying constellation symbols of the data portion of the frame. The purpose of the pilots is to facilitate tracking of the clock drift between the transmitter and the receiver. Another purpose of the pilots may be to facilitate refinement and/or tracking temporal variations in the channel estimates. In OFDM systems, the pilots are typically distributed in a two dimensional pattern over time (i.e. OFDM symbols) and frequency (i.e. subcarriers). Additionally (or alternatively), the pilots comprise known value OFDM symbols interleaved within the data carrying OFDM symbols.

In cases where the data portion comprises pilots, the likelihood L_{HYP} of a given hypothesis HYP is determined by comparing the expected values of the pilot symbols s=(s₁, s₂, . . . , s_{K}) with the respective received values r_{HYP}=(r₁, r₂, . . . , r_{K})_{HYP} according to the given hypothesis HYP, L_{HYP}=Pr(r_{HYP}|s).

Note that in cases where hypothesis selection is based on error detection and/or on reliability indications derived from the channel decoder, evaluating the likelihood of a given hypothesis requires decoding of the hypothesis. Thus, the channel decoder is applied multiple times per hypothesis. In cases where hypotheses validation is based on pilots, evaluating the likelihood of a given hypothesis typically does not require decoding of the hypothesis, and thus the channel decoder is typically applied only once, after the valid hypothesis have been selected.

In another embodiment, hypothesis selection is also based on a combination of the above methods. For example, pilot based selection is attempted first, applying error detection based selection only in cases where the pilot based selection does not provide definitive results. Additionally (or alternatively), pilot based selection can be used to reduce the number of hypotheses being decoded by the channel decoder.

Also illustrated in FIG. 15 is the case where the guard interval of the header OFDM symbols H1 through H4 is set to zero. Thus, the duration of the header OFDM symbols is equal to the duration of the preamble symbols. In this case, the boundaries of the FFT application F4 to F10 are valid for all hypotheses which makes hypotheses based frame synchronization more efficient. In cases where the guard interval of the header symbols is not equal to zero, hypothesis bases frame synchronization may still be implemented. In this case, however, the FFT process may need to be applied multiple times, with different boundaries, to accommodate for the differences in the boundaries of the header symbols of the different hypotheses.

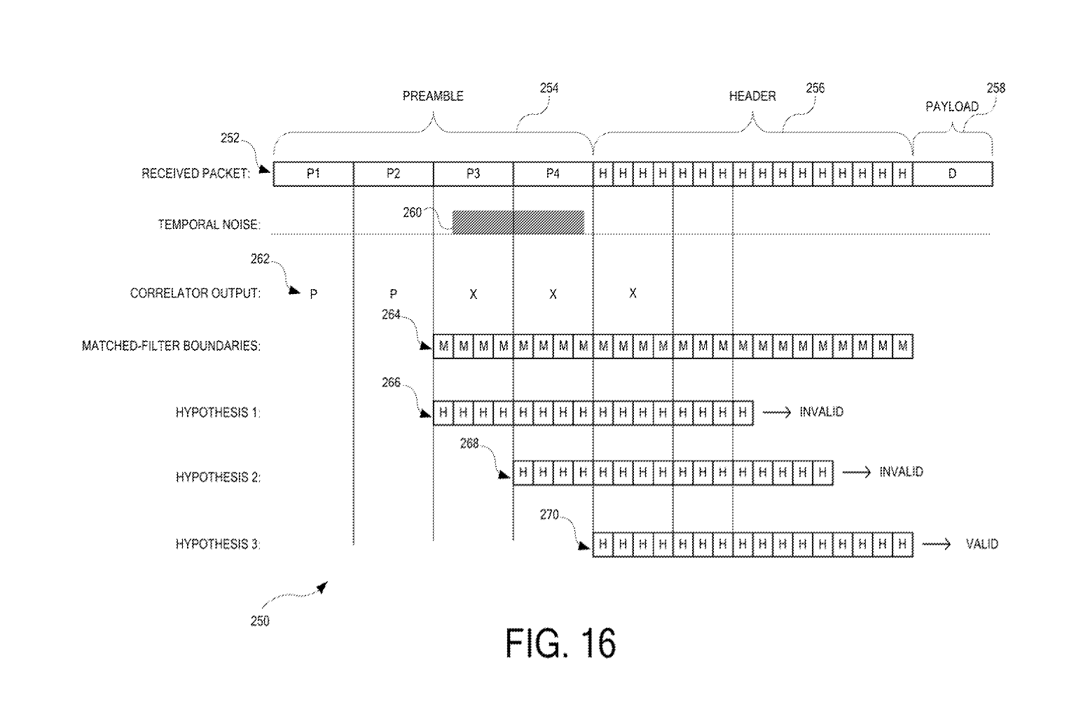

A diagram illustrating an example hypotheses-based frame synchronization mechanism in a single carrier communication system is shown in FIG. 16. The hypothesis-based frame synchronization scheme, generally referenced 250, comprises on the first line 252 a transmitted frame consisting of symbols received from the communications medium. The transmitted frame comprises a preamble portion 254, header portion 256 and a payload portion 258. The preamble 254 comprises a plurality of identical preamble symbols, denoted P1 to P4. The header 256 comprises several symbols denoted H. FIG. 16 is similar to that of FIG. 15 and the description of FIG. 15 applies to FIG. 16 as well, with some variations related to the differences between single carrier and OFDM systems.

The main differences are that (1) in single carrier systems the header (and the payload) comprises constellation symbols, rather than OFDM symbols; (2) the duration of a header constellation symbol is typically much shorter than the duration of the preamble symbol; and (3) the constellation symbols are detected by a matched filter rather than by FFT application.

The second line of FIG. 16 illustrates a burst 260 of high noise that affects the received packet. Note that all lines of FIG. 16 are displayed over a common time axis. In the example illustrated, the burst of high noise corrupts preamble symbols P3 and P4. The burst noise is introduced in order to illustrate the operation of the hypothesis-based frame-synchronization in the presence of such noise. It is appreciated, however, that the hypothesis-based frame-synchronization mechanism is suitable in other applications as well, e.g., in cases where P′ is set equal to P, or in cases where the SNR is too low to distinguish between P and P′.

The third line 262 of FIG. 16 illustrates the boundaries at which the correlation process is applied to the received signal. The receiver determines the boundaries of the matched filter 264 (denoted in the figure by M) based on symbol synchronization. The duration of the matched filter is equal to the duration of the header constellation symbol (denoted in the figure by H). In order to facilitate efficient testing of the multiple hypotheses, the duration of the header symbol is adapted to be an integer multiple of the preamble symbol, thus enabling utilizing the same matched filter inputs for all hypotheses. In an alternative embodiment, the duration of each preamble symbol is adapted to be an integer multiple of the duration of at least a portion of the data symbols (i.e. header and data symbols).

It is noted that the examples illustrated in FIGS. 15 and 16 refer to systems where P′=P. The hypothesis-based frame synchronization mechanism, however, is useful also for systems where P′≠P, because of the low reliability of hypothesis selection based on P′ alone, as described supra. Furthermore, P′≠P may be considered as part of the pilots and utilized for pilot based selection, as described supra.

### Periodic Noise Estimation

Many communication systems are subject to time varying ingress noise, and in some of those cases the temporal variations of the ingress noise are periodic, at a period referred to as the noise period. In some PLC systems, for example, the noise period is determined by the zero crossing (ZC) period of the mains (i.e. AC cycle), which is typically 10 or 8.3 ms, depending on the mains frequency 50 or 60 Hz, respectively.

With reference to FIGS. 4 and 5, the receiver of a communication system (either single carrier or OFDM) typically comprises a detector (98 FIG. 4; 116 FIG. 5) and a channel decoder (99 FIG. 4; 119 FIG. 5). In many cases, the decoder is fed by soft decision values, e.g., log likelihood ratio (LLR) values calculated by the detector. The quality of the soft decisions and the overall system performance are considerably improved if the detector is provided with a reliable estimation on the expected level of the noise associated with each constellation symbol. For example, in BPSK or QPSK modulation, the LLR values are usually calculated as follows:

$$L L R ( x ) = log \frac{Pr ( r = x \vert s = + 1 )}{Pr ( r = x \vert s = - 1 )} = \frac{2 \cdot x}{v} \qquad ( 5 )$$

where r is the receive symbol, x is the normalized received value, s is the transmitted symbol and v is the variance of the noise.

In cases where the noise is relatively constant, v is usually taken to be the average variance of the noise. Furthermore, in many cases, e.g., where the channel encoder is a convolutional encoder and the channel decoder is a Viterbi decoder, scaling of the LLR values by a constant does not affect the decoder and the constant value of v is not important.

When the variance of the noise exhibits high variations over time, however, system performance may be significantly improved provided that the detector is able to obtain a good estimate vₖ of the noise variance during the reception of symbol k, and use vₖ rather than the average v in calculating the LLR values.

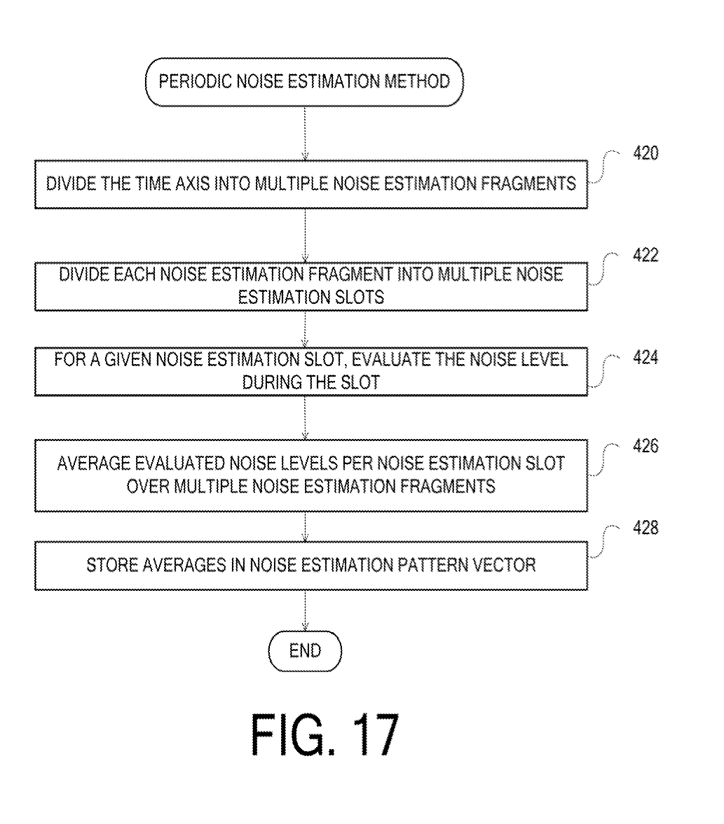

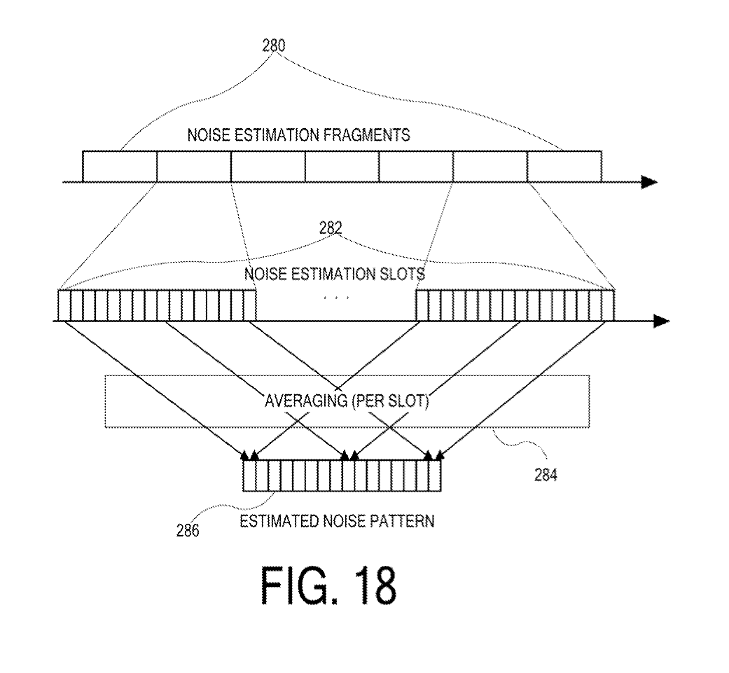

A flow diagram illustrating an example periodic noise estimation method of the present invention is shown in FIG. 17. A diagram illustrating an example mechanism for estimating the pattern of temporal variations of the noise in a single carrier communication system is shown in FIG. 18.

With reference to FIGS. 17 and 18, the receiver is operative to divide the time axis into noise estimation fragments 280 (step 420), where the duration of the noise estimation fragments is typically equal to the duration of the expected period of the noise. In PLC systems, for example, the duration of the noise estimation fragments is typically 10 or 8.3 ms, according to the mains frequency of 50 or 60 Hz, respectively. Each noise estimation fragment 280 is further divided into noise estimation slots 282 (step 422), the duration of which is typically close to or shorter than the desired granularity of the noise estimation process. In single carrier PLC systems, for example, the noise estimation slot may be on the order of 0.1 ms.

For a given noise estimation slot within a given noise estimation fragment, the receiver evaluates the level of the noise during the given slot (step 424). The evaluated noise levels are averaged, per slot, across the fragments 284 (step 426) and stored in an estimation noise pattern 286 (step 428), which comprises a vector whose length is equal to the number of slots per fragment. Thus, the receiver averages the evaluated noise levels of the n^{th} slot over a plurality of fragments, and stores the result in the n^{th} entry of the estimated noise pattern 286. Averaging is typically performed using any suitable technique such as a “forgetting filter”, e.g., a leaky integrator.

For example, consider the case where the duration of a noise estimation fragment, which is equal to the noise period, is 10 ms and the duration of a noise estimation slot is 0.1 ms. In this case, the noise estimation pattern comprises a vector x of 100 entries, x=[x(1), x(2), . . . , x(100)]. During a given n^{th} noise estimation slot of a given m^{th} noise estimation fragment, the receiver evaluates the variance y(m, n) of the noise during the given slot, using one of the methods described below or using any other suitable method, and updates the value of noise estimation pattern x(n) according to a suitable averaging method, e.g., in accordance with the following leaky integrator equation

x_{new}(n)=(1−α)·xₚᵣₑᵥᵢₒᵤₛ(n)+α·y(m,n) (6)

where α is the forgetting factor of the leaky integrator which determines the rate at which old values are forgotten.

Periodic noise estimation is typically performed during idle intervals (i.e. when the receiver is open, but no packet is being received). Noise evaluation during idle intervals is typically performed by measuring the energy of the input signal since the signal received is considered to consist only of ingress noise. The start of an idle interval is typically indicated by the end of packet transmission or by the end of packet reception. The end of an idle interval is typically indicated by a start of a packet transmission or by a start of packet reception. Start of packet reception is typically indicated by the synchronizer upon symbol synchronization.

In some cases, periodic noise estimation may also be performed during packet detection. Noise evaluation during idle intervals may be performed using blind noise estimation, by decision-directed noise estimation, or by a combination thereof.

In blind noise estimation, an attribute related to the received signal is measured and compared with the expected value of the attribute. The noise is estimated respective to the deviation of the measured value from the expected value. In some cases, the attribute used for blind noise estimation is related to an individual constellation symbol. For example, in cases of constant energy modulation, such as BPSK or QPSK, blind noise estimation may be performed by comparing the energy of a given constellation symbol, before or after the matched filter, with its expected value. In other cases, the attribute used for blind noise estimation may be related to a plurality of symbols. For example, in cases of constant energy modulation, such as BPSK or QPSK, blind noise estimation may be performed by comparing the energy of the signal at neighboring constellation symbols with each other, before or after the matched filter.

In decision directed noise estimation, the expected received signal is calculated based on the decisions. The noise is evaluated by measuring the energy of the difference between the actual and the expected received signal. In one embodiment, the decisions may be obtained from the output of the detector. In another embodiment, the decisions may be obtained from the output of the channel decoder. In another embodiment, the decisions may be substituted by known data, such as pilot data. Those cases are referred to as data directed noise estimation.

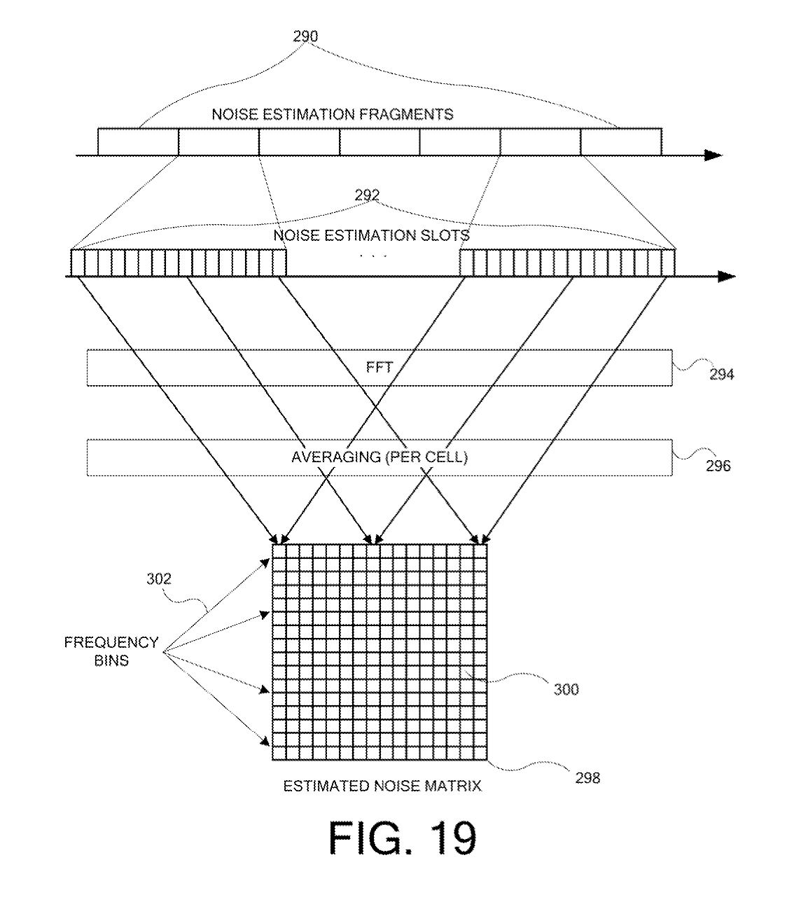

A diagram illustrating an example mechanism for estimating the pattern of temporal variations of the noise in an OFDM communication system is shown in FIG. 19. Note that the scheme of FIG. 19 is similar to that of FIG. 18 and the description of FIG. 18 applies to FIG. 19 as well with some variations related to the differences between single carrier and OFDM systems.

One major difference between single carrier and OFDM systems is that in the latter system the constellation symbols are transmitted over different subcarriers, also referred to as frequency bins. Therefore, it is advantageous to estimate the noise per frequency bin. Therefore, in OFDM systems the receiver maintains a noise estimation matrix 298, rather than the one dimensional estimated noise pattern 286 of FIG. 18. Each noise estimation cell 300 within noise estimated matrix 298 represents a given frequency bin 302 within a given noise estimation slot.

As in the scheme of FIG. 18, the receiver is operative to divide the time axis into noise estimation fragments 290, where the duration of the noise estimation fragments is typically equal to the duration of the expected period of the noise. Each noise estimation fragment 290 is further divided into noise estimation slots 292, the duration of which is typically close to or shorter than the desired granularity of the noise estimation process.

For a given noise estimation slot within a given noise estimation fragment, the receiver evaluates the level of the noise during the given slot using FFT application 294. The evaluated noise levels are averaged, per cell, across the slots 296 and stored in an estimation noise pattern matrix 298.

Another major difference between single carrier and OFDM systems is that in the latter noise evaluation applies to the output of the FFT. In PLC channels, the noise period is determined by the AC cycle of the mains. The nominal value of the mains frequency is typically either 50 or 60 Hz, and the nominal value of the noise period is, therefore, 10 or 8⅓ ms., respectively. The mains frequency is not stable, however, and typically exhibits variations of more than ±0.5%, due to variations in the instantaneous load. Therefore, periodic noise estimation requires synchronization of the PLC node to the AC cycle.

In one embodiment, synchronization to the AC cycle is performed utilizing a phase lock loop (PLL), which adjusts the phase of the noise estimation fragments to the phase of the AC cycle.

In another embodiment, a zero-crossing detector is incorporated in or connected to the PLC node, which functions to sense the AC voltage and determine the zero-crossing points (i.e. the points when the AC voltage changes its sign). In such cases, the zero-crossing triggers produced by the zero-crossing detector may be used to drive the PLL. In one embodiment, each zero-crossing trigger initiates a new noise estimation period. In another embodiment, the time difference between the zero-crossing trigger and the starting point of the noise estimation fragment produces an error signal, and the tracking loop advances or delays the starting point of the noise estimation fragment according to the sign and magnitude of the error signal. The tracking loop can be a tracking loop known in the art, such as a first order or a second order loop, or some other tracking loop suitable for use with the invention.

In an alternative embodiment, where a zero-crossing trigger is not available, an error signal for the tracking loop may be obtained by detecting phase shifts of the noise pattern, for example, by means of an early-late detector.

In single carrier systems, early-late detection typically operates as follows. Let x(n), for n=1, 2, . . . , N, represent an estimation noise pattern of a single carrier PLC receiver, where N is the number of noise estimation slots, and let y(m, n) denote the evaluated noise levels during the m^{th} noise estimation fragment. The early-late detector calculates an error signal e(m) as given below:

$$e ( m ) = \frac{{\sum }_{n = 1}^{N - 1} x ( n ) \cdot y ( m , n + 1 ) - {\sum }_{n = 2}^{N} x ( n ) \cdot y ( m , n - 1 )}{{\sum }_{n = 1}^{N} {x}^{2} ( n )} . \qquad ( 7 )$$

In OFDM systems, early-late detection operates in a similar way, but over a two dimensional noise estimation matrix, rather than a one dimensional noise estimation vector, and generates the error signal as given below:

$$e ( m ) = \frac{\begin{matrix}{\sum }_{n = 1}^{N - 1} {\sum }_{f = 1}^{F} x ( n , f ) \cdot y ( m , n + 1 , f ) - \\ {\sum }_{n = 2}^{N} {\sum }_{f = 1}^{F} x ( n , f ) \cdot y ( m , n - 1 , f )\end{matrix}}{{\sum }_{n = 1}^{N - 1} {\sum }_{f = 1}^{F} {x}^{2} ( n , f )} , \qquad ( 8 )$$

where f=1, 2, . . . , F denotes the subcarriers.

The estimated noise pattern is typically used to improve the detection. In single carrier systems, when a given constellation symbol is detected, the detector calculates the relative location of the given symbol within the current noise estimation fragment, determines the respective noise estimation slot n, and utilizes the n^{th} entry of the noise estimation vector for calculating the LLRs of the bits derived from the given constellation symbol.

In OFDM systems, when a given OFDM symbol is detected, the detector calculates the relative location of the given symbol within the current noise estimation fragment, determines the respective noise estimation slot n, and utilizes the n^{th} column of the noise estimation matrix for calculating the LLRs of the bits derived from the given OFDM symbol.

Additionally (or alternatively), the estimated periodic noise pattern may be utilized in any other operations involving calculations which are based on the noise variance. For example, the estimated periodic noise pattern may be utilized for synchronization and/or for channel estimation, both in single carrier and OFDM systems.

In OFDM systems, for example, the frequency domain channel estimation can be improved by averaging over multiple preamble symbols. In this embodiment, the estimated periodic noise pattern is utilized for weighted averaging rather than simple averaging. For example, let h(f, n), for n=1, 2, . . . , N, denote a set of N frequency domain channel estimates obtained from N preamble symbols, where f=1, 2, . . . , F denotes the frequencies (i.e. subcarriers), and let x(f, n) denote the respective N columns in the estimated noise matrix. Optimal combining of the individual channel estimation h(f, n) is performed according to the maximum ratio combining (MRC) principle given as follows to obtain the combined channel estimate h(f):

$$h ( f ) = \frac{{\sum }_{n = 1}^{N} h ( f , n ) / x ( f , n )}{{\sum }_{n = 1}^{N} 1 / x ( f , n )} . \qquad ( 9 )$$

### Periodic Channel Estimation

In some communication systems the channel response varies periodically over time, at a period referred to as the channel period. In some PLC systems, for example, the channel period is equal to the noise period, which is typically 10 or 8.3 ms, depending on the mains frequency (50 or 60 Hz, respectively).

In some cases, the periodic variations of the channel are relatively minor, and coherent detection may be successfully performed based on a fixed channel estimation determined during the synchronization stage, as explained above. In some cases, however, improved performance may be obtained by estimating the periodic pattern of the channel response and utilizing this pattern for purposes of better detection.

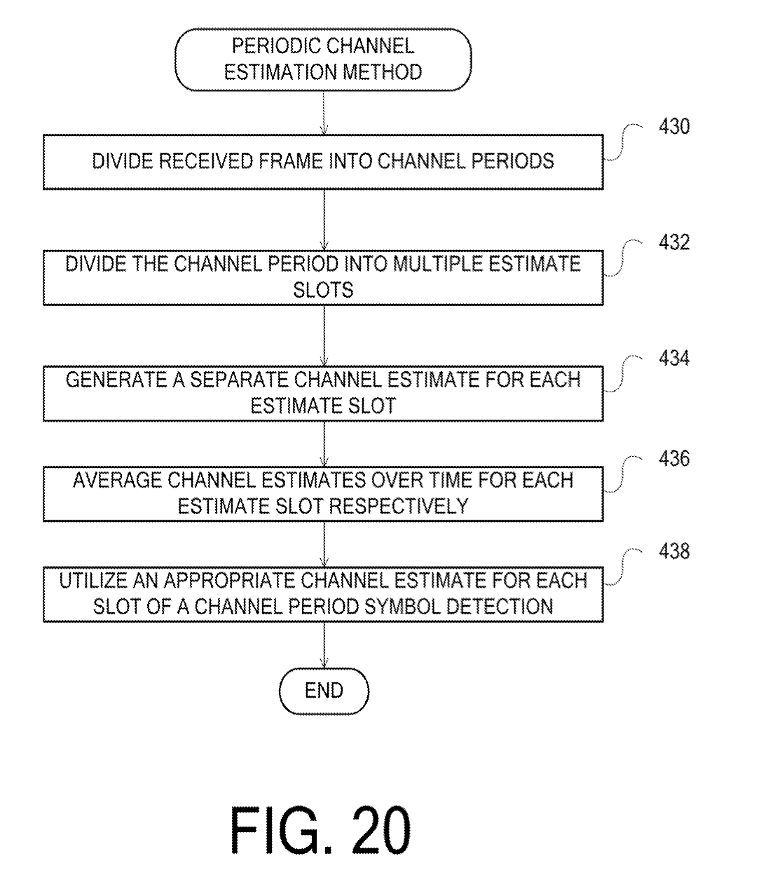

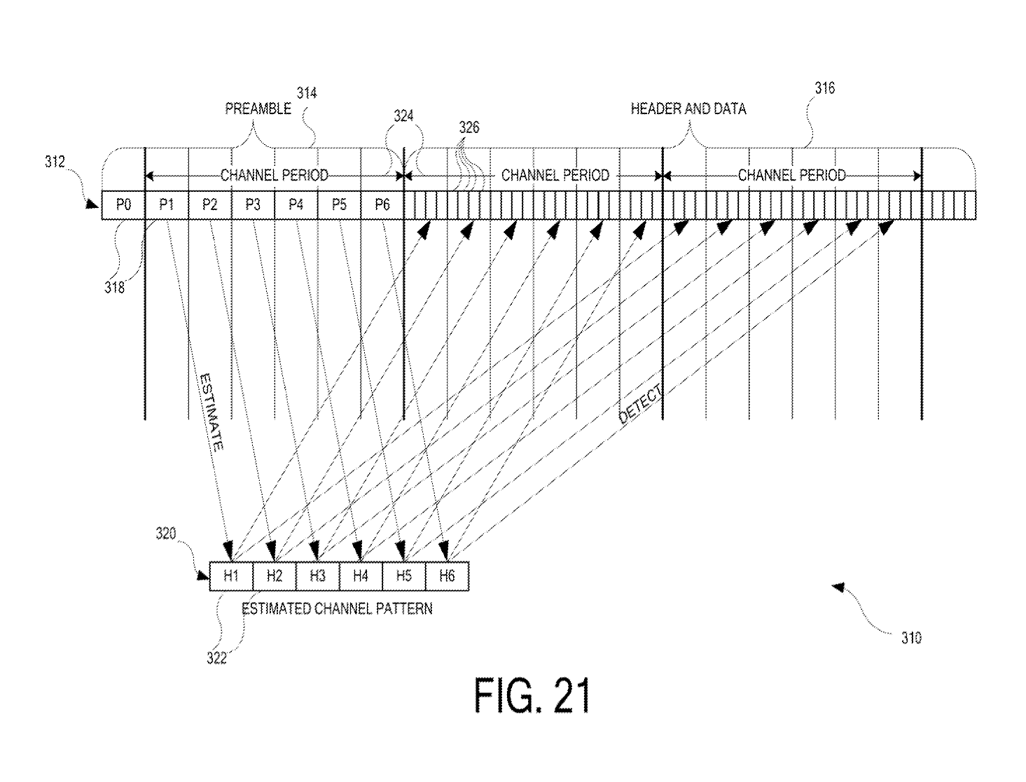

A flow diagram illustrating an example periodic channel estimation method of the present invention is shown in FIG. 20. A diagram illustrating an example mechanism for estimating a periodically varying channel response in a single carrier system is shown in FIG. 21.

With reference to FIGS. 20 and 21, in accordance to this mechanism, generally referenced 310, the preamble 314 comprises a plurality of symbols 318, denoted in the figure P0 to P6, where the number of symbols is adapted to make the total duration of the preamble be substantially equal to or longer than the duration of the channel period 324. Each preamble symbol is used to generate a channel estimate 322, which refers to a given time location within the channel period wherein the set of channel estimates is referred to as the periodic channel estimation pattern 320. In the example embodiment illustrated, the preamble symbols P1 to P6 are used to produce channel estimates h1 to h6. Note that P0 is not used in this example to produce a channel estimate in order to reflect the fact that the first symbols of the preamble might, in some cases, be unavailable for channel estimation, e.g., due to the response time of the AGC.

Thus, the first step in performing periodic channel estimation is to divide the received frame into channel periods (step 430). The channel periods are further divided into multiple estimate slots (step 432). Using the preamble symbols, a separate channel estimate is generated for each estimate slot (step 434). Note that the number of estimate slots typically (but not necessarily) matches the number of preamble symbols.

The channel estimates generated for each respective estimate slot are averaged over time (step 436). During detection and decoding of the header and payload, an appropriate channel estimate for each slot of a channel period is used for symbol detection (step 438).

The resolution of the periodic channel estimation may be adapted to the duration of the preamble symbols. The resolution, however, may be increased using interpolation between adjacent channel estimates. Furthermore, the quality of the channel estimates may be improved by averaging over neighboring estimates.

During the detection of the header and the payload 316, the receiver determines, for each given constellation symbol, the relative location of the given symbol 326 within the channel period 324, and selects the respective channel estimate 322 for the detection of the given symbol, thereby improving the quality of the detection.

In an alternative embodiment where the header and/or the payload comprise known constellation symbols (e.g., pilots), the receiver further improves the channel estimates during the detection based on the known symbols. This is referred to as data directed channel estimation. Additionally (or alternatively), the receiver may employ decision directed channel estimation in order to further improve the channel estimates.

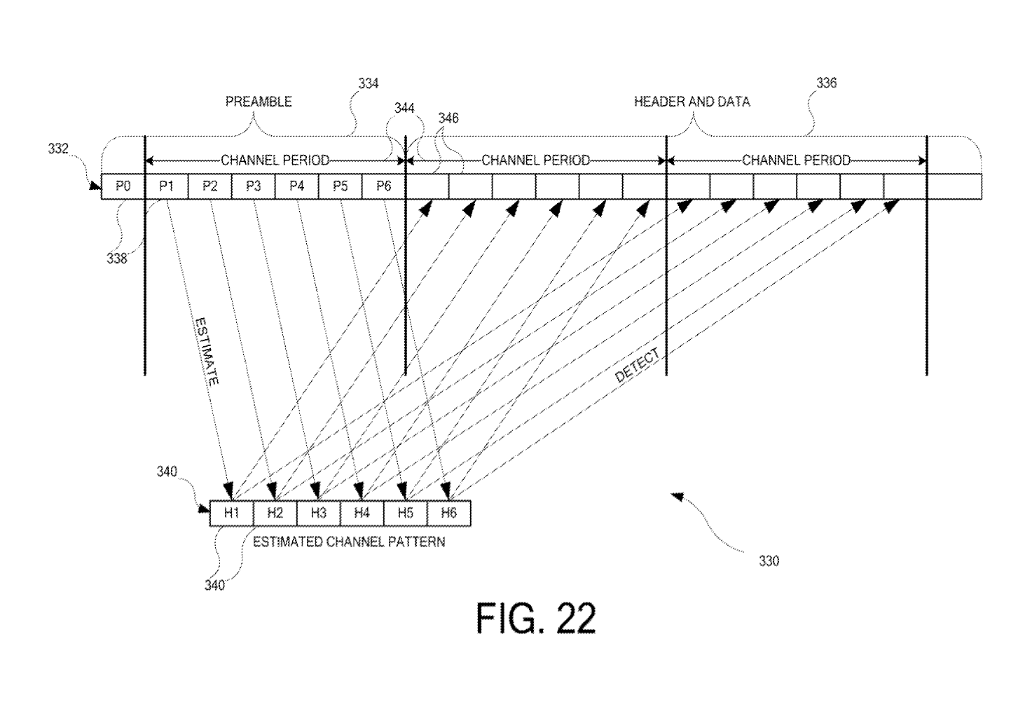

A diagram illustrating an example mechanism for estimating a periodically varying channel response in an OFDM system is shown in FIG. 22, The scheme of FIG. 22, generally referenced 330, is similar to that of FIG. 21 and the description of FIG. 21 is applicable to FIG. 22 as well with some variations related to the differences between single carrier and OFDM systems.

In OFDM systems, the channel estimates are typically presented in the frequency domain rather than in the time domain. Therefore, the channel estimates in FIG. 22 are denoted by H (H1 to H6) rather than by h (as in FIG. 21). Furthermore, the duration of the OFDM symbols of the header and the payload is typically substantially equal (up to the guard interval) to the duration of the preamble symbols. This is also illustrated in FIG. 22.

The preamble 334 comprises a plurality of symbols 338, denoted in the figure P0 to P6, where the number of symbols is adapted to make the total duration of the preamble substantially equal to or longer than the duration of the channel period 344. Each preamble symbol is used to generate a channel estimate 342, which refers to a given time location within the channel period wherein the set of channel estimates is referred to as the periodic channel estimation pattern 340. In the example embodiment illustrated, the preamble symbols P1 to P6 are used to produce channel estimates H1 to H6. Note that P0 is not used in this example to produce a channel estimate in order to reflect the fact that the first symbols of the preamble might, in some cases, be unavailable for channel estimation, e.g., due to the response time of the AGC.

During the detection of the header and the payload 336, the receiver determines, for each given constellation symbol, the relative location of the given symbol 346 within the channel period 344, and selects the respective channel estimate 342 for the detection of the given symbol, thereby improving the quality of the detection.

The frequency domain representation of the channel estimates and the OFDM format of the detected symbols, enable improvement of the channel estimates during the detection of the header and/or the data, by means of data and/or decision directed channel estimation.

### Adaptive Bit Loading

Adaptive bit loading, or more specifically frequency-based adaptive bit loading, is a common practice in some OFDM systems. In frequency-based adaptive bit loading, the transmitter applies different transmission settings to different subcarriers based on the expected SNR in each subcarrier. The different transmission settings may comprise combinations of one or more of transmission parameters such as coding rate, repetition level, modulation scheme or any other suitable parameters.

In some systems where the channel response and/or the noise pattern vary periodically over time, time-based or time/frequency-based bit loading is employed. In PLC systems, the channel period and the noise period are typically equal. Taking those PLC systems as a typical example, we refer in the following description to those two equal periods as the period, with no qualifications.

In time-based adaptive bit loading, the transmitter applies different transmission settings to different time locations within the period based on the expected SNR at the respective locations within the period. Time based adaptive bit loading is applicable both to single carrier and OFDM systems.

In frequency/time-based adaptive bit loading, the transmitter applies different transmission settings to different subcarriers at different time locations within the period based on the expected SNR at the respective subcarrier and locations within the period. Time/frequency based adaptive bit loading is naturally applicable to OFDM systems but not to single carrier systems.

Adaptive bit loading is usually determined by the receiver or is based on recommendations forwarded by the receiver to the transmitter. The receiver usually determines the adaptive bit allocation based on the periodic channel estimation and/or based on the time or time/frequency periodic noise estimation, which may be obtained as described above.

### Elimination of the Guard Interval

The channel response of many communication systems is not an ideal impulse and exhibits some level of delay spread. In single carrier systems, the delay spread of the channel introduces inter-symbol interference (ISI) between adjacent constellation symbols which is typically addressed using some type of equalization technique. In OFDM systems, the relative level of the ISI is typically lower, since the OFDM symbols are typically longer and therefore the ratio between the delay spread and the symbol duration is lower.

In order to further reduce (and virtually eliminate) the ISI, traditional OFDM systems employ cyclic extension techniques. In cyclic extension, a cyclic prefix is added to the basic OFDM symbol (i.e. the output of the IFFT). The size of the cyclic prefix, also referred to as the guard interval (GI) is adapted to be essentially longer than the expected delay spread of the communication channel. Upon reception, the receiver disregards the guard interval and processes only the basic OFDM symbol or actually a cyclically shifted version of the basic OFDM symbol. Since the delay spread is typically shorter than the guard interval, the basic OFDM symbol processed by the receiver is essentially ISI free, and no equalization is required, which makes OFDM a preferred communication method in many communication systems.

Some OFDM communication systems are adapted to operate in a range of scenarios including cases of very low SNR. Some PLC systems, for example, are adapted to operate at SNR values ranging from about −10 db to above +20 db. In such cases, the range of transmission parameters (i.e. FEC encoding, repetition encoding and constellation mapping) is adapted to include cases of very low SNR conditions. Furthermore, the transmission parameters of the header, which are intended to cover all expected channel conditions, are typically adapted to accommodate the lowest SNR.

In cases where the transmission parameters are adapted to very low SNR levels (e.g. SNR levels below −5 db), the guard interval may be eliminated (i.e. set to zero). One potential benefit of elimination of the guard interval is facilitation of efficient hypothesis-based frame synchronization, described in detail supra.

Another potential benefit of elimination of the guard interval is improvements to the spectral efficiency. In cases where the transmission parameters are adapted for very low SNR, improvement of the spectral efficiency is achieved without degrading the power efficiency as demonstrated in the following example.

Consider, for example, the case where the duration of the guard interval is 25% of the basic OFDM symbol and the transmission parameters are adapted for a minimal SNR of −10 db. Eliminating the guard interval may either create or increase the ISI. The duration of the additional ISI caused by removing the guard interval, however, cannot exceed the duration of the guard interval, which is 25% of the basic OFDM symbol. Therefore, the level of the additional ISI cannot exceed −6 db of the energy of the desired signal. Under these conditions, the minimal SNR will increase by about 0.1 db, while the spectral efficiency is improved by almost 1 db, which amounts to an improvement of about 0.9 in the E_{b}N₀.

### Time Diversity

In many communication systems the channel conditions (i.e. the ingress noise and/or the channel response) vary over time. In such communication systems, the use of one or more time diversity (TD) techniques can potentially significantly improve the performance of the system. In time diversity, a block of K information symbols (typically information bits) in the transmitter is adapted to transmit a plurality of symbols related to a given information bit at diverse times. In cases where channel conditions (i.e. the channel response and/or noise level) vary over time, time diversity enables the receiver to determine the value of a given information bit according to the plurality of symbols received at diverse times. The assumption is that the symbols received at diverse times are subject to different channel conditions, thus improving the probability that every information bit is received correctly. Time diversity is typically implemented in blocks (referred to hereinbelow as segments) and described in more detail infra.

In many communication systems the ingress noise and/or the channel response vary periodically over time, at a period referred to as the noise period or the channel period, respectively. In some PLC systems, for example, the noise and/or the channel response vary with the AC cycle, at a period of 10 or 8.3 ms, depending on the mains frequency. In such communication systems, time diversity can significantly improve system performance.

In time diversity communication systems, it is advantageous to match the time diversity span (i.e. the duration of the time diversity segments) to the channel and/or noise period. This matching provides the optimal exploitation of the varying channel conditions with minimal latency. If the time diversity span is shorter than the channel period, the full potential of using time diversity techniques is not exploited. Conversely, if the time diversity span is longer than the channel and/or noise period, excessive latency is unnecessarily introduced. Furthermore, if the time diversity span is not an integer multiple of the channel/noise period, the full potential of the time diversity is not exploited, even though the time diversity span is longer than the channel and/or noise period.

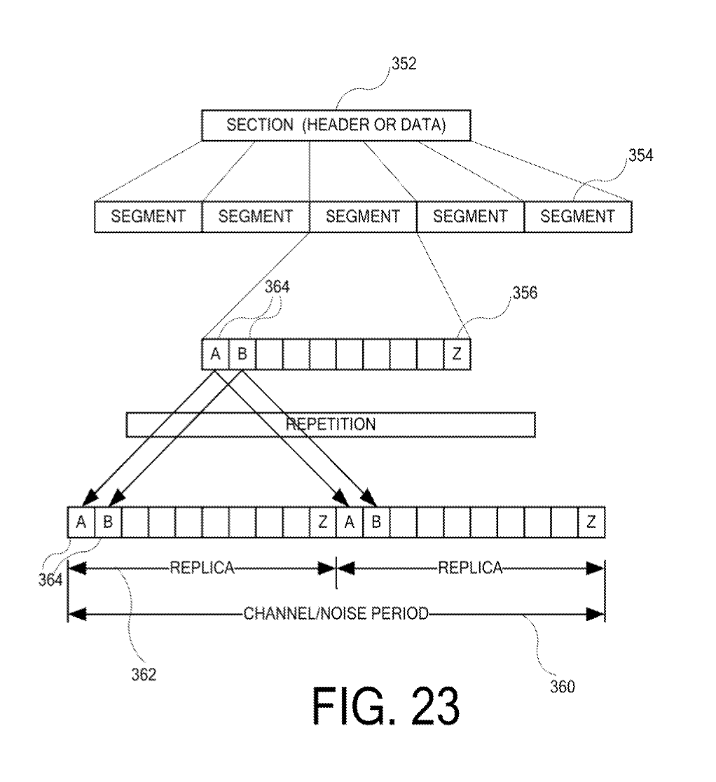

A diagram illustrating an example time diversity mechanism in a single carrier system is shown in FIG. 23. In this example time diversity scheme, generally referenced 350, a section 352 (i.e. a header or a payload section) of a packet comprises time diversity segments 354 wherein each segment comprises constellation symbols 356. The constellation symbols of a segment 354 are repeated N times, thus producing N replicas of the segment (N=2 in the example embodiment shown in FIG. 23). The duration of the transmitted segment (after repetition) is adapted to be essentially (substantially) equal to the channel and/or noise period 360. As shown in FIG. 23, the repetitions (replicas 362) of each constellation symbol 364 are separated as far as possible within the channel/noise period 360, thus obtaining maximal diversity over the varying channel conditions. For example, the duration between the repetition of symbol ‘a’ 366 is maximized over the channel/noise period 360.

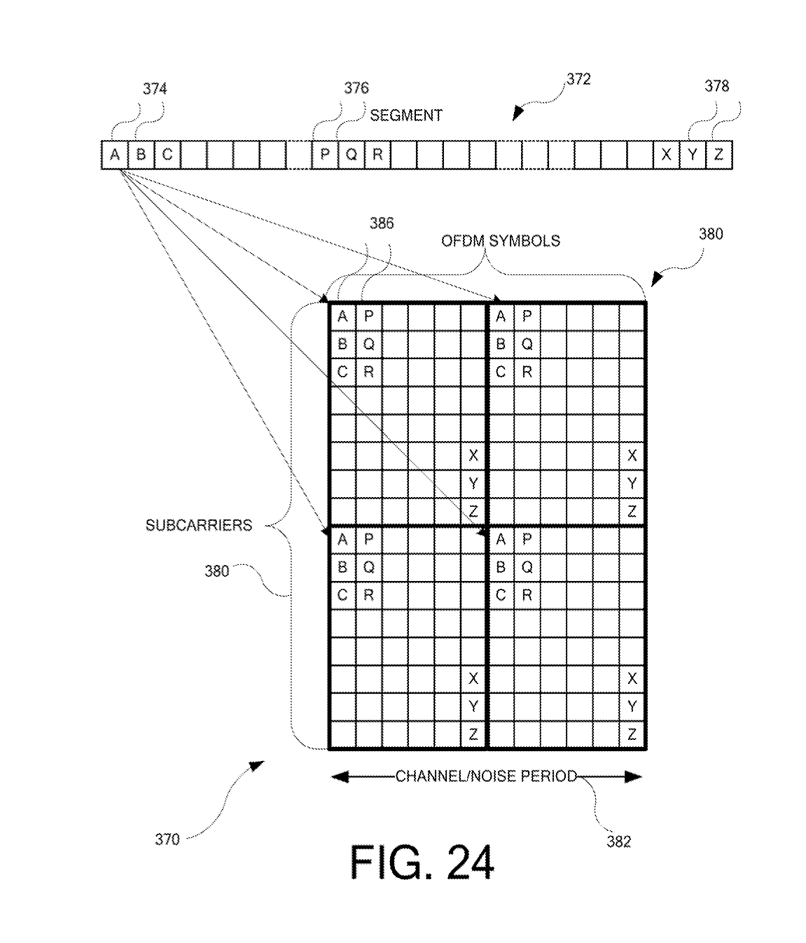

A diagram illustrating an example time diversity mechanism in an OFDM system is shown in FIG. 24. In an OFDM system, time diversity is usually combined with frequency diversity as shown in FIG. 24. In this example time diversity scheme, generally referenced 370, segment 372 of length 4MN constellation symbols (including symbols 374, 376, 378) is mapped into a block 380 comprising M OFDM symbols 386, with N subcarriers 384 in each OFDM symbol. The duration of the M OFDM symbol block is adapted to the channel/noise period 382.

In the example embodiments of FIGS. 23 and 24, repetition is applied to constellation symbols. In other cases, repetition may be applied to bits, prior to constellation modulation. Note that the schemes shown in FIGS. 23 and 24 are examples of time diversity, with or without frequency diversity. It is appreciated that numerous other time diversity examples are known in the art. In some embodiment, there is no explicit repetition, since enough redundancy is obtained by the FEC encoder. In other embodiments, block repetition is replaced by an interleaver. In other embodiments, bit repetition takes place before an interleaver. In other embodiments, block repetition takes place either before or after an interleaver. In other embodiments, combinations of the above mentioned schemes are employed. In other embodiments, other suitable methods may be used, as is known in the art. Whenever the channel conditions vary periodically in time, however, better performance, at minimal latency, is usually achieved by adapting the duration of the diversity segment to be substantially equal to the duration of the channel and/or noise period.

### Variable Duration Header

With reference to FIG. 3, packet 70 typically comprises preamble 72 and data portion 74, which typically comprises header 76 and payload 78. The transmission parameters of the payload are usually adapted to the expected channel conditions of the packet, and therefore differ from packet to packet. Consider that since many communication systems operate over a large variety of channel conditions, which typically vary from link to link, they are adapted to transmit the payload using a large variety of transmission parameters. For example, some PLC systems, operating within the range of 50 to 500 kHz, are adapted to transmit the payload using (1) modulation schemes with various numbers of bits per constellation (e.g., BPSK, QPSK and 16 QAM); (2) FEC encoders with various rates (e.g., 1:2 and 3:4); and (3) repetition encoders with various rates (e.g., 1:1 to 1:16). In such systems, the spectral efficiency of the payload, under various transmission parameters, may vary between approximately 3 bits/Hz/second and 0.06 bits/Hz/second, which is a ratio of about 1:50 between the maximal and the minimal spectral efficiency.

Due to the variety of transmission parameters associated with the payload, these parameters are typically not known a priori at the receiver. Therefore, the header comprises those parameters, thus enabling the receiver to detect and decode the payload. As for the transmission parameters of the header, those parameters are typically predefined or preconfigured into the nodes, thus enabling detection and decoding of the header.

Since the predefined or preconfigured transmission parameters of the header preferably should match any channel conditions which might be expected, those parameters are usually selected to provide high robustness, at the expense of low spectral efficiency. In PLC systems, where the worst case channels are much worse than the typical channels and where the typical payloads are relatively short, the low spectral efficiency of the header may significantly reduce the throughput of the system.

Consider for example a case where the typical payload length is 128 bytes, the typical payload spectral efficiency is approximately 1 bit/Hz/second, the length of the header is 8 bytes and the spectral efficiency of the header is 0.06 bits/Hz/second. Under those conditions, the duration of the header is about 1:1 of the duration of the typical payload, which significantly reduces the typical throughput of the system.

Furthermore, when time diversity is applied, the spectral efficiency of the header may be further reduced in order to generate enough encoded constellation symbols to fill a time diversity segment. Consider, for example, a PLC system operating over a 100 to 500 kHz band, where the length of the header is 8 bytes and the duration of the time diversity segment is 8.3 ms. In this example, the spectral efficiency of the header, in the case where time diversity encoding is applied, is reduced to about 0.2 bits/Hz/second.

As described supra, the transmission parameters of the header are usually pre-defined or pre-configured, which implies a penalty of transmitting relatively long headers regardless of the actual channel conditions.

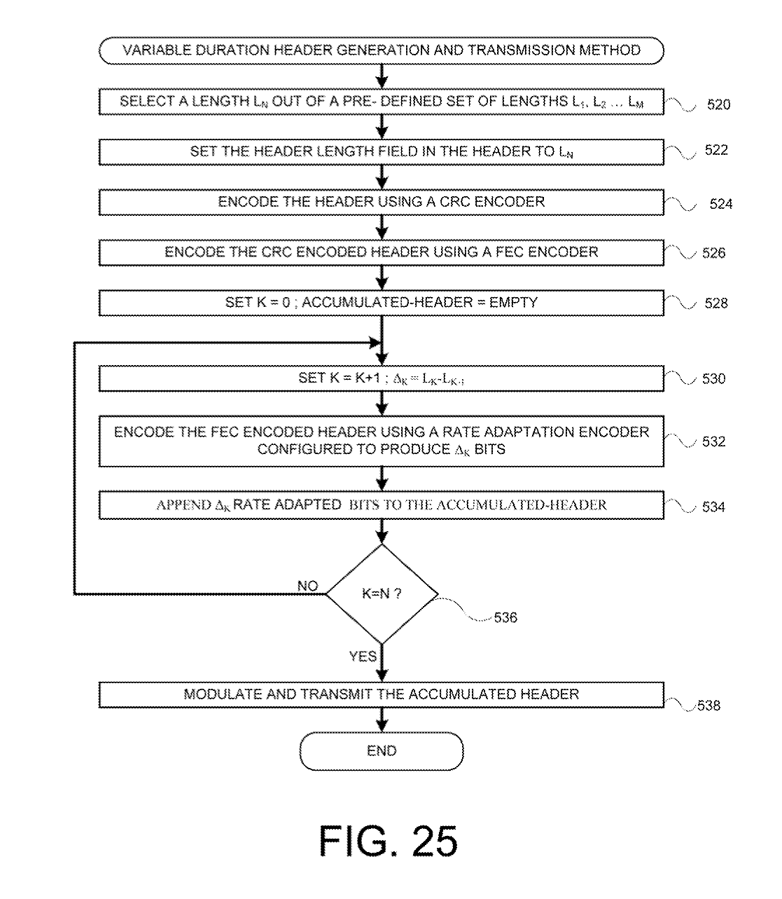

The present invention provides mechanism for improving system throughput by controlling the duration of the header. A flow diagram illustrating an example variable duration header generation and transmission method of the present invention is shown in FIG. 25. First, the receiver selects a length L_{N} for the header to be generated (step 520). The length L_{N} is selected out of a pre-defined or pre-configured set of M header lengths L₁, L₂ . . . L_{M}, which is known to both the transmitter and the receiver. Note that typically the set of header lengths is common to all nodes within a given network. In one embodiment, the length L_{N} is selected to provide high probably of reception by all intended receivers of the packet. In some cases, where access to the medium is determined to be responsive to virtual carrier sense, which is obtained by decoding the header, the length L_{N} is selected to provide high probability of reception of the header by all nodes within the given network.

In order to determine the starting point of the payload, the receiver needs to know the length of the header. The header length, however, cannot be determined by the receiver by only decoding the header, as described infra. Therefore, the header format needs to comprise an indicator of the header length, e.g., a field comprising N or L_{N}. In step 522, the header length field is set to L_{N} (or to N). The header bits are then encoded by an error detection code (EDC) which typically comprises a CRC (step 524). The EDC-encoded header bits are then encoded by a FEC encoder (step 526), resulting in N_{FEC/HEADER} FEC-encoded header bits. In some embodiments, the FEC encoder comprises a convolutional code. In other embodiments, the FEC encoder comprises any suitable FEC encoder.

The following steps 530, 532, 534, 536 comprise a loop of N iterations. Initially, the loop is initialized by setting the iteration index K to zero and the accumulated-header to the empty state (step 528). The loop index K is then incremented and the difference Δ_{K} between the next and current lengths (L_{K}−L_{K-1}) is calculated (step 530). The N_{FEC/HEADER} FEC-encoded header bits are then encoded using a rate adaptation encoder configured to generate Δ_{K} bits (step 532), and the resulting Δ_{K} rate adapted bits are interleaved and appended to the accumulated-header (step 534).

It is then checked if the index K is equal to N (step 536). If not, the method continues with step 530 for another iteration and generates and appends an additional Δ_{K+1} header bits to the accumulated-header thus extending it. Once the index K is equal to N (step 536), generation of the accumulated header is complete. The accumulated header is then modulated and transmitted (step 538).

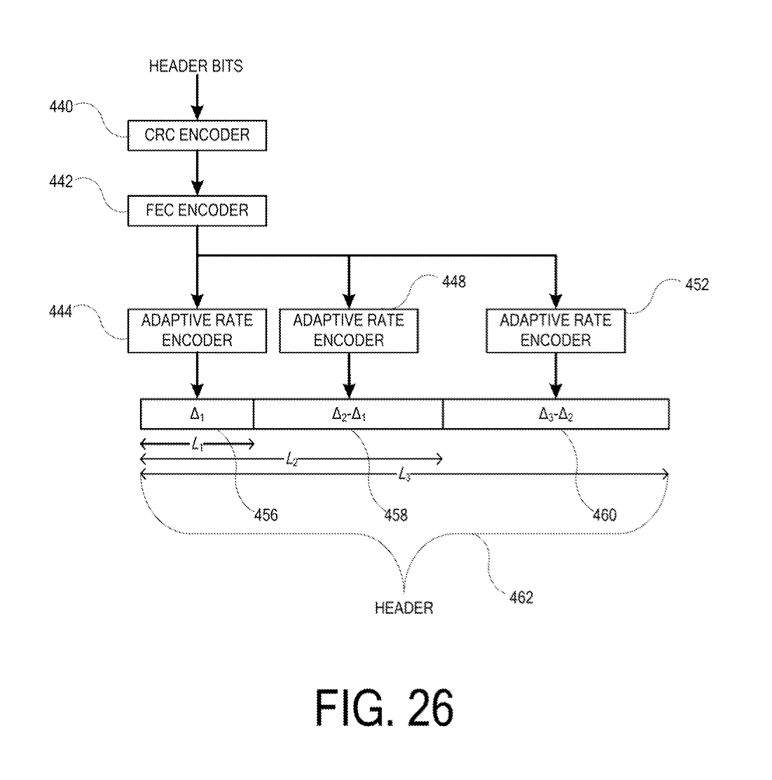

A diagram illustrating the generation of an example variable size header for use with the variable header duration mechanism of the present invention is shown in FIG. 26. The scheme is operative to generate a variable length header 462, which is encoded to have one of M different lengths L₁, L₂, . . . , L_{M}, such that a header of length L_{N}, for N>1, is an extension of the header of length L_{N-1}. In the example embodiment shown in FIG. 26, M=3 and the header may be encoded at three durations (i.e. lengths) 456, 458 and 460, denoted as L₁, L₂ and L₃, respectively. In PLC systems, a typical configuration may be to set M=2, where length L₁ is selected to provide enough redundancy to accommodate the worst case channel in cases where time diversity is not required and where length L₂≧L₁ is selected to span over an integer number of zero crossing periods. The header bits are encoded by an error detection code (e.g., CRC encoder) 440 and than encoded by a FEC encoder 442. According to the value of N, the FEC-encoded header bits are encoded by the first N of the M adaptive-rate encoders 444, 448 and 452, to generate a header of length L_{N}.

Rate adaptation encoders 444, 448 and 452 are configured to produced Δ₁, Δ₂ or Δ₃ bits, respectively, where Δ₁=L₁ and Δₖ=L_{K}−L_{K-1}. In one embodiment, rate adaptation comprises a combination of one or more of the following operations: (1) bit repetition (i.e. repeating certain bits a given number of times), (2) bit elimination (i.e. discarding some of the bits), and (3) bit permutation (i.e. changing the order of the bits). In some cases, bit elimination comprises puncturing, i.e. discarding the bits according to a given repetitive pattern. In other cases, especially when permutation is also implemented, bit elimination may comprise discarding some of the last bits. In some cases, bit permutation is referred to as interleaving.

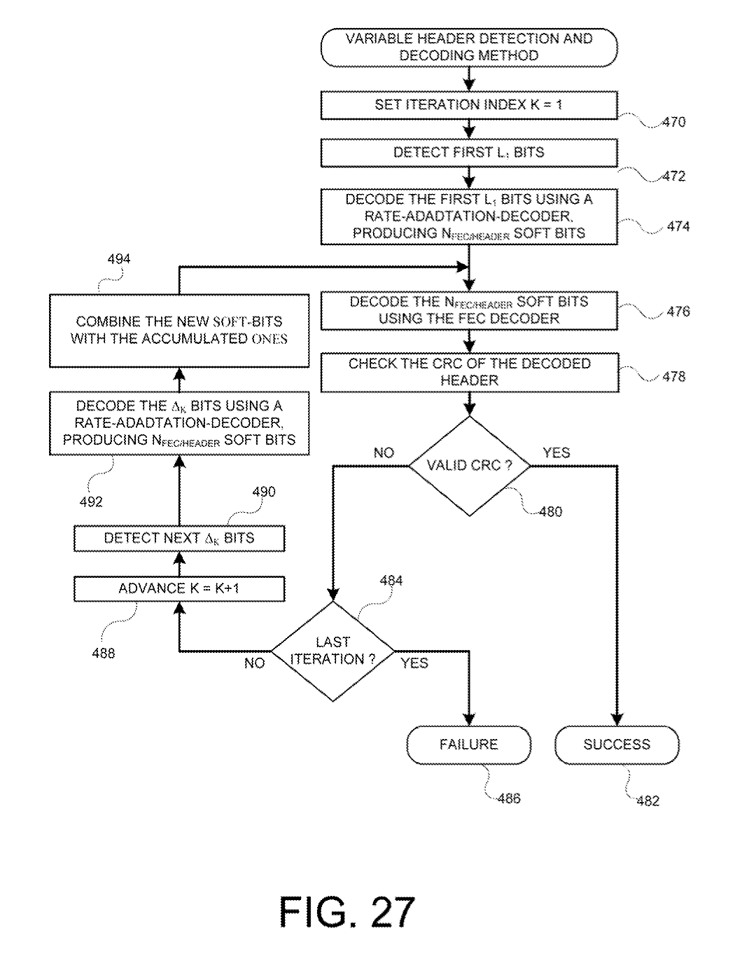

A flow diagram illustrating an example variable duration header process for detecting and decoding the variable length header is shown in FIG. 27. In accordance with the method, detection and decoding is performed iteratively. The iteration index K is initialized to one (step 470). In the first iteration, the receiver detects a sufficient number of symbols to generate at least L₁ bits (step 472), which are typically soft bits (e.g., LLRs or other suitable metrics). The L₁ detected soft bits are decoded using a rate-adaptation decoder, which is configured to reverse the operation of a complimentary first rate-adaptation encoder (i.e. the rate adaptation encoder configured to generate L₁ bits in the method of FIG. 25), and to generate N_{FEC/HEADER} soft-bits (typically LLRs) corresponding to the N_{FEC/HEADER} FEC-encoded header bits (step 474). The N_{FEC/HEADER} soft-bits are decoded using a FEC decoder which is configured to reverse the operation of the complimentary FEC encoder, and generate (if the decoding is successful) a received replica of the transmitted EDC-encoder header bits (step 476). The received replica of the EDC-encoder header bits is decoded by an error detection decoder, e.g., CRC decoder (step 478). If the error detection decoder indicates an error free result (e.g., the CRC is valid) (step 480), the header detection method terminates successfully (step 482). Otherwise, if the current iteration is the last iteration (i.e. K=M) (step 484), packet reception is terminated with a failure (step 486). If the current iteration is not the last iteration (step 484), the receiver proceeds to the next iteration (step 488).

In the K^{th} iteration, for K>1, the receiver detects additional symbols to generate at least an additional Δ_{K} soft-bits (step 490), decodes the additional soft-bits using a rate-adaptation decoder configured to reverse the operation of a K^{th} rate-adaptation encoder and generates new N_{FEC/HEADER} soft-bits (step 492). The new N_{FEC/HEADER} soft-bits are combined with the N_{FEC/HEADER} soft-bits accumulated during the previous iterations to generate an updated version of the accumulated N_{FEC/HEADER} soft-bits (step 494).

The rate-adaptation decoder of iteration K is configured to reverse the operation of the respective rate adaptation encoder. Repetition is reversed by combining of soft-bits (usually summation of LLR values), elimination is reversed by substituting ‘don't care’ soft-bits (usually zero LLR values) and a given permutation is reversed using the inverse permutation. In one embodiment, combining the new soft-bits with the accumulated ones typically comprises summation of LLR values.

Successful detection and decoding of the header based on the first Lₙ bits, where n<N, does not necessarily indicate that the header duration is actually Lₙ. On the contrary, in many cases, the receiver may detect and decode the header successfully based on the first Lₙ bits, while the actual duration of the transmitted header is Lₘ bits, for some m>n. Therefore, the header bits typically comprise the duration Lₘ of the header, so as to enable the receiver to calculate the starting point of the payload and avoid the necessity of further detection and decoding iterations.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of synchronization for use in a communication system coupled to a communications medium, said method comprising:
receiving a packet over said communications medium, said packet comprising a preamble having a plurality of preamble symbols and a data portion having a plurality of data symbols;
determining symbol synchronization based on detection of one or more preamble symbols;
generating a plurality of candidate hypotheses, each candidate hypothesis comprising a different sequence of symbols;
determining a likelihood value of each candidate hypothesis indicating the likelihood the candidate hypothesis is valid; and
selecting a candidate hypothesis based on said likelihood values.

2. The method according to claim 1, wherein said step of determining a likelihood value comprises passing each candidate hypothesis through an error detector and using the results thereof to select one of said candidate hypotheses as most probable.

3. The method according to claim 2, wherein said likelihood value comprises a Cyclic Redundancy Code (CRC).

4. The method according to claim 1, wherein said step of determining a likelihood value of a hypothesis and selecting one of said hypotheses as most likely is based on detecting known symbols within a header portion of said data symbols.

5. The method according to claim 1, wherein said step of determining a likelihood value of a hypothesis and selecting one of said hypotheses as most likely is based on reliability indications generated by detecting and decoding the symbols of each candidate hypothesis.

6. The method according to claim 1, wherein a first hypothesis is determined according to the location of the last preamble symbol positively detected.

7. The method according to claim 1, wherein a last hypothesis is determined according to the location of the first preamble symbol positively detected.

8. The method according to claim 1, wherein a last hypothesis is determined in accordance with the location of the first preamble symbol positively detected and a maximum number of preamble symbols.

9. The method according to claim 1, wherein the total number of candidate hypotheses generated is determined in accordance with a maximum number of preamble symbols.

10. The method according to claim 1, wherein said set of candidate hypotheses comprise a sequence of consecutive hypotheses.

11. The method according to claim 1, wherein the guard interval between transmitted header symbols in said data portion is zero.

12. The method according to claim 1, wherein the number of symbols in said preamble is dynamically selected in accordance with expected channel conditions.

13. A method of synchronization for use in a Power Line Carrier (PLC) based communication system connected to a power line utility, said method comprising:
receiving a packet over said power line utility, said packet comprising a preamble portion having a plurality of preamble symbols and a data portion having a plurality of header symbols and data symbols;
obtaining symbol synchronization based on positive detection of one or more preamble symbols;
generating a plurality of hypotheses, each hypothesis comprising a unique sequence of received symbols;
determining a likelihood value for each hypothesis, said likelihood value representing the probability of a particular hypothesis being valid; and
selecting one of said hypotheses having a corresponding likelihood value indicating it is most likely to be valid.

14. The method according to claim 13, wherein at least a portion of said data portion is encoded by an error detection code, and wherein evaluating the likelihood value of a given hypothesis comprises decoding said error detection code.

15. The method according to claim 13, wherein said header symbols are encoded by an error detection code, and wherein evaluating the likelihood value of a given hypothesis comprises decoding said error detection code.

16. The method according to claim 13, wherein said header symbols are encoded by a Cyclic Redundancy Code (CRC), and wherein evaluating the likelihood value of a given hypothesis comprises matching CRCs.

17. The method according to claim 13, wherein at least a portion of said data portion is encoded by a channel encoder, and wherein evaluating the likelihood value of a given hypothesis comprises evaluating soft reliability information generated by a complimentary channel decoder.

18. The method according to claim 17, wherein said channel encoder comprises a convolutional encoder, said channel decoder comprises a Viterbi decoder, and evaluating said soft reliability information comprises evaluating path metrics generated by said Viterbi decoder.

19. The method according to claim 13, wherein at least a portion of said data portion comprises one or more pilot symbols, and wherein evaluating the likelihood value of a given hypothesis comprises comparing expected values of said pilot symbols with respective received symbols.

20. The method according to claim 19, wherein at said one or more pilot symbols comprise known value OFDM symbols interleaved within the data OFDM symbols.

21. The method according to claim 13, wherein said preamble portion and said data portion comprise Orthogonal Frequency Division Multiplexing (OFDM) symbols, and wherein said OFDM symbols of at least a portion of said data portion comprise zero guard intervals.

22. The method according to claim 13, wherein said data portion comprises constellation symbols modulated with single carrier modulation, and wherein the duration of said preamble symbols and the duration of at least a portion of said data portion constellation symbols are adapted such that the duration of said preamble symbols is an integer multiple of the duration of said data portion constellation symbols.

23. The method according to claim 13, wherein the number of symbols in said preamble is dynamically selected in accordance with expected channel conditions.

24. A modem for use in a Power Line Carrier (PLC) based communication system connected to a power line utility, comprising:
a transmitter operative to generate and transmit packets over said power line utility, each packet comprising a preamble portion consisting of preamble symbols and a data portion consisting of data symbols;
a receiver coupled to said power line utility and operative to:
receive packets over said power line utility;
obtain symbol synchronization based on positive detection of one or more preamble symbols in a receive packet;
generate a plurality of hypotheses, each hypothesis comprising a unique sequence of received symbols;
determine a likelihood value of each hypothesis, said likelihood value representing the probability of a particular hypothesis being valid; and
select one of said hypotheses having a corresponding likelihood value indicating it is most likely to be valid.

25. The modem according to claim 24, wherein said step of determining a likelihood value comprises passing each candidate hypothesis through an error detector and using the results thereof to select one of said candidate hypotheses as most probable.

26. The modem according to claim 24, wherein said step of determining a likelihood value of a hypothesis and selecting one of said hypotheses as most likely is based on detecting known symbols within a header portion of said data symbols.

27. The modem according to claim 24, wherein said step of determining a likelihood value of a hypothesis and selecting one of said hypotheses as most likely is based on reliability indications generated by detecting and decoding the symbols of each candidate hypothesis.

28. The modem according to claim 24, wherein a first hypothesis is determined according to the location of the last preamble symbol positively detected.

29. The modem according to claim 24, wherein a last hypothesis is determined according to the location of the first preamble symbol positively detected.

30. The modem according to claim 24, wherein a last hypothesis is determined in accordance with the location of the first preamble symbol positively detected and a maximum number of preamble symbols.

31. The modem according to claim 24, wherein the total number of candidate hypotheses generated is determined in accordance with a maximum number of preamble symbols.

32. The modem according to claim 24, wherein the guard interval between transmitted header symbols in said data portion is zero.

33. The modem according to claim 24, wherein the number of symbols in said preamble is dynamically selected in accordance with expected channel conditions.

34. A method of digital communications, said method comprising:
transmitting a packet comprising a preamble portion and a data portion, wherein said preamble portion comprises a plurality of preamble symbols and said data portion comprises a plurality of data symbols; and
wherein the duration of each preamble symbol is an integer multiple of the duration of at least a portion of said data symbols.

35. The method according to claim 34, wherein said data portion comprises a header, wherein said header comprises a plurality of header symbols, and wherein the duration of said preamble symbols is an integer multiple of the duration of said header symbols.

36. The method according to claim 34, wherein said data portion comprises Orthogonal Frequency Division Multiplexing (OFDM) symbols comprising zero guard interval, and wherein the duration of said preamble symbol is an integer multiple of the duration of the duration of said OFDM symbols comprising zero guard interval.

37. The method according to claim 34, wherein said data portion comprises a header portion, wherein said header portion comprises Orthogonal Frequency Division Multiplexing (OFDM) symbols comprising zero guard interval, and wherein the duration of said preamble symbols is an integer multiple of the duration of said header symbols.

38. The method according to claim 34, wherein at least a portion of said data portion comprises one or more pilot symbols, wherein said one or more pilot symbols comprise known value Orthogonal Frequency Division Multiplexing (OFDM) symbols interleaved within data carrying OFDM symbols.

39. The method according to claim 34, wherein the number of symbols in said preamble is dynamically selected in accordance with expected channel conditions.
